(19) United States
(12) Patent Application Publication
(10) Pub. No.: US 2011/0022545 A1
(43) Pub. Date: Jan. 27, 2011

(54) Re-inventing carmaking

(75) Inventor: Edward Gordon Durney, Millbrae, CA (US)

Correspondence Address: PATENT STRATEGIES, 11 ROSALITA LANE, MILLBRAE, CA, 94030, US

(73) Assignee: A Truly Electric Car Company, Millbrae, CA (US)

(21) Appl. No.: 12/509,425

(22) Filed: Jul. 24, 2009

(51) Int. Cl. B62D 65/04; G06Q 90/00

(52) U.S. Cl. 705/500

(57) ABSTRACT

Better cars and better carmaking—they can solve problems like oil depletion, global warming, and the dying carmaking industry. But how do we get them? Modularity. Cars can be modular in design, production and use. Making cars using modularity will change the car industry. Now a very vertical industry where a few huge companies sell just complete cars, carmaking can change to a horizontal industry where thousands of companies sell car modules. Carmaking can become like the computer industry—innovative, vibrant, profitable. And modularity allows “mass customization”—tailoring a product to each buyer, but selling it at a mass production price. Like hand-tailored suits at off-the-rack prices. This invention brings that concept to cars. Cars are made out of black-box modules, and buyers choose from among different versions of each module. That makes buyer choice expand while price remains low.

### FIELD OF INVENTION

Carmaking.

### Outline

A. My Vision
1. Better Cars
2. Better Carmaking

B. A Brief History of Carmaking
1. Craft Production
2. Mass Production
3. Lean (“Just In Time”) Production
4. The Future: Modularity

C. Basics of Modularity
1. Modular Design
2. Modular Production
3. Modular Use
4. Mass Customizing
5. The Power of Modularity

D. How a Modular Car Might Work
1. Car Operating System
2. Driver Control Unit
3. Wheel/Motors
4. Motor Controls
5. Power Unit
6. Car Body
7. Car Chassis

E. Carmaking in Crisis
1. Global Warming and Oil Depletion
2. Layoffs and Labor Unions
3. Horrible Financials
4. Commodity Pricing
5. Fewer Buyers

F. Why Modularity in Carmaking?
1. Horizontal Industry, Not Vertical
2. More Players But More Profit
3. No Need for Big Incentives or Full Floorplan Financing
4. Everyone Gets a “One of a Kind” Car
5. More Design Freedom
6. Intellectual Property Gains Value
7. Carmakers Can Focus on Brand and Forget Factories
8. Demand “Pulls” Production of Cars
9. Innovation Speeds Up
10. Steady Revenue Over a Car's Life

G. Problems to Watch For
1. Complexity and Cost
2. Less Reliability, Durability, Safety
3. Innovation Can Be Held Back
4. Litigation and Government Regulation
5. The Paradox of Choice
6. The Problem with Standards

H. Forming a Framework for Modularity
1. Divide Car Functions Into “Black Box” Modules
2. Define Interfaces Between Modules
3. Set Standards for Module Architecture and Interfaces
4. Develop Tests for Modules and Assembled Cars

I. Bringing Modularity to Carmaking
1. Modular Design in Carmaking
2. Modular Production in Carmaking
3. Modular Use in Carmaking

J. Other Ways Modularity in Carmaking Might Work
1. Each Car Mass-Customized for Its Owner
2. Car Industry Players Take New Roles
3. Car Made Only after Ordered by Buyer, But Quickly
4. Buy Modules from Best-of-Class Suppliers
5. Use Carmaker Brand on Modules Made by Others
6. Modules Assembled Locally, to Fit Locality
7. At Delivery, Carmaker Helps New Owner Customize Car
8. Carmakers Can Use Modules Made By Others
9. Buyers Can Mix and Match Modules
10. Upgrade Modules, Not the Whole Car
11. Seeking Investors in a Specific Technology
12. Special Functions Sold as Add-On Modules
13. ?

K. The Drawings

### A. MY VISION

El Capitan looms over California's Yosemite Valley. This mass of granite (the biggest on the face of the earth) rises sharply from the valley floor. One kilometer—up. If you stand next to it, El Capitan overwhelms. One climber said touching El Capitan feels like putting your hand on the side of a planet.

People thought El Capitan unclimbable. Until 1958, it was. That year three climbers scaled El Capitan after a “siege” that took 47 days spread over 16 months. Teams first secured trails of manila ropes using pitons hammered out of stove legs and other junkyard metal. Then came a final bottom-to-top push—12 days of hand-over-hand climbing—that conquered the rock by brute force.

Later climbers did not take as long. Equipment improved. Techniques did too. The second climb in 1960 took 7 days instead of 47. Months became weeks. Then weeks became days. Routes and strategies were plotted, meter by meter. In 1975 days became hours, when a team took only one day to make the climb.

Now, some fifty years after the first climb, two-person teams of “speed climbers” scale the 1,000-meter “nose” route up El Capitan in less than 3 hours. Six meters a minute, straight up. What took 47 days ending in November 1958 took 164 minutes one July morning in 2008. That record too did not stand long.

My vision is that our cars—the technology in them—can get better just as dramatically.

1. Better Cars

Look at computers. Fifty years ago computers were not very well known. Sure, they were impressive for their time. But only a few hundred computers were in use. Not many people had the specialized knowledge to use a computer. Nor did they have the need to—computers could not do much.

Back then, memory was measured in thousands of bytes. You could see with the naked eye the small iron rings that were one bit of “core” memory. These huge machines sprawled across reinforced floors in special air-conditioned rooms. Even tended carefully, they often broke. They were tightly integrated, had few manufacturers, and evolved at a slow pace. By today's standards, they were dinosaurs.

Today, a computer small enough to sit on a lap can do things that fifty years ago the most advanced computer, weighing tons, could not. Computer memory is now measured in billions of bytes. Hard disk drives hold a trillion. Flat displays in full color show moving images just like a television. Even someone like me, who has worked with computers all his life, can hardly believe the advances that have been made.

Compare that to our cars. They too have changed, but much less dramatically. Our cars still work much the way they did 50 years ago. Or even 100 years ago. We sit in front of a steering wheel, with pedals at our feet, and drive a car powered by controlled explosions under the hood. Nothing fundamental has changed.

We need to change the way the world moves. Global warming, oil depletion, energy security, a dying carmaking industry—all these issues push us to make rapid change. Yet change in our cars is incremental. Some of the time, we go backward.

Take gas mileage, for example. Today's cars (when you include “light trucks”) get worse gas mileage on average than 20 years ago. Some are worse than the Model T. A hundred years in development and cars still get lousy gas mileage. That's not much evolution.

Gas mileage has plenty of room to improve. The Society of Automotive Engineers sponsors a super-mileage competition for colleges each year. The student teams build small, quirky “cars” that roll on bicycle wheels. A prone driver must go between 10 and 20 miles per hour around a flat track, powered by a 1½ horsepower gasoline engine.

That's not exactly a real-life test. But the winner now gets fuel efficiency of thousands of miles a gallon. Not hundreds—thousands. One car got 3,150 miles on a gallon of gas. A similar car in a different contest did even better, at over 7,000 miles per gallon. In a modern car, on average less than 1% of the energy from the gasoline it burns goes to move the car's driver. That leaves plenty of room to improve.

Other power sources push cars further on even less. In another competition—the World Solar Challenge—specially built “cars” go the 1,896 miles over the Australian outback from Darwin to Adelaide powered just by the sun. That's at high speed too—a recent winner averaged 60 miles per hour.

But these cars are just concepts, not even close to prototype stage, that will never make it to our roads. We need better cars, and on our roads now. By now we should all be driving better cars, like these super-mileage and solar cars. Or even better.

Where are the cars that get hundreds, or thousands, of miles to the gallon? Or drive themselves? Where are the cars that run on nuclear power? Or get their power just from the sun? Where are the cars that link together like trains? That cut through the air like airplanes? Or even fly? Where are those cars?

It's the future now. Even so, we still don't have the cars of the future. We could just accept that, and say, as Yogi Berra said, “the future ain't what it used to be.” But those cars can become reality. Not now. But soon.

How? The power of modularity can create them. We do not really know what future cars will look like, or how they will work. But we can make cars evolve as dramatically as climbing El Capitan did, and how the computer industry still does. Let's look at how modularity can turn carmaking around.

2. Better Carmaking

Midway through 2009, carmaking is in crisis. Two American carmakers—GM and Chrysler—are bankrupt. The third, Ford, labors under a load of debt. Even the best-carmakers, like Toyota, struggle. For carmakers, forget growth. The carmaking industry has instead been shrinking in size. Only its losses grow. Carmaking has become a stagnant, dying, money pit of an industry.

That contrasts starkly with the computer industry. Computers have evolved at a dramatic pace. As a result, the computer industry has grown explosively. Not only that, but computers have changed every other industry—banking, communications, entertainment, transportation, retail sales. Even spawned new industries, like the Internet.

That dramatic pace of change continues. Moore's Law still holds. New computer technology hits the market almost daily. Computers become obsolete sitting on store shelves. That makes for a vibrant industry. Many of the best opportunities for investors have been, and continue to be, in information technology.

What makes the computer industry so innovative, so vibrant, so profitable? Credit modularity for that. In a landmark book published in 2000, two Harvard Business School professors say modularity powered the computer industry to its current heights. In fact, their book is subtitled “The Power of Modularity.” They make a persuasive argument. (More from that book later.)

Intel co-founder Andy Grove adds to the argument. In his book “Only the Paranoid Survive,” Grove notes how the computer industry changed when the vertical become horizontal. Vertically integrated companies died off. Companies competing horizontally replaced them.

A few huge companies (IBM, Burroughs, Univac, DEC) had dominated computing. The only players were “vertical silos” that made the whole computer (both hardware and software) and sold only complete computers.

That changed. The dinosaurs—huge, vertical companies—disappeared. Smaller, more nimble companies competing in horizontal market segments took over the computer industry. FIG. 2(a) shows how this worked. (In Section F(2) below I discuss this history in more detail.)

The change was startling. The computer industry took off.

Today, the computer industry has become innovative, vibrant, profitable. It has, in fifty years, come a remarkably long way. Hard to believe, when you think about how the industry started. Just like climbers are scaling El Capitan today in less than 3 hours when it once took 47 days, the computer industry is far different today.

Why the difference between cars and computers? Carmakers spend tremendous resources doing research and development. In fact, carmakers might spend more than any other industry. That keeps new cars improving in performance, price, and prestige. Yet nothing close to the computer industry in innovation, vibrancy, or profits.

That should change. I think carmaking can succeed as an industry, with many thriving companies. Each one able to compete strongly, attract investment, offer stable jobs, innovate quickly, and make a profit. Carmaking might then rival, or even overtake, the computer industry in its allure to creative people, companies, and investors.

Then the carmakers can make better cars. They can do all we want—each of us with our different needs and desires—yet adapt to changing challenges, like global warming and oil depletion. These cars can transform transportation, economically and socially. These cars can change the way the world moves.

Better cars and better carmaking. Modularity will make them. Here's why.

### B. A BRIEF HISTORY OF CARMAKING

How does modularity differ from carmaking today? To help understand that, let's take a brief look at carmaking's history. I'll start with the craft production of the early days. Then the mass production of Henry Ford's era. Then the current lean production first developed by Toyota. I'll end with modularity.

1. Craft Production

Carmaking began as a craft industry. The first cars were built by hand. A team of craftsmen would build a car from basic components. Sheet steel would be cut, pounded into shape, and fastened onto the frame. Parts were made to fit with each other. A part on one car would differ in size (although usually not by much) from the same part on another car.

Often the body was made by a different company than the chassis. Results of craft production were usually good—many of the cars were well-crafted works of art. But these cars took a long time to build. Skilled and experienced craftsmen were needed to make each part of the car. Unskilled labor was minimal. All that made them very expensive.

Europe led the way in craft carmaking. Early carmakers did not try to make a standard car model. Just like a painter paints a different picture on each canvas, a carmaker made each car different from the others. The first standard car model was the 1894 Benz Velo, made in Germany. Benz made 134 mostly identical Velos in 1895.

Americans came a little late to the game. In 1896, Frank Duryea was the biggest producer in the United States, turning out 13 units. In America, too, the cars were hand-built. Mass production of machines as complicated as a car was still years away.

Ransome Eli Olds made the first standard car model in the United States, the Curved Dash Oldsmobile. Olds made 425 of these cars in 1901, using a primitive version of an assembly line to do it. That marked the first move to mass production. And since Olds made the cars in Detroit, he started the carmaking industry's focus on the Detroit area.

Still, the largely craft production in both Europe and the United States limited the car market to the rich. But Henry Ford and other early carmakers felt that big money could be made by expanding the car market to the middle class, and even the working class. To do that, carmaking needed to change.

2. Mass Production

Henry Ford changed carmaking. He started humbly. A Detroit neighborhood—including Henry's wife Clara—heard pounding in the middle of a June night in 1896. Ford had built a new “quadricycle” in his shed. When Ford finished the car, quite a complex one for its time, he had no way to get it out of the shed. So at 2 a.m. he took an ax to the shed wall, pushed the car to the street, and drove it off. It worked.

Ford's first cars were largely hand made, following the first carmakers in Europe and New England who hand-built one car at a time. Ransome Eli Olds had wanted to mass-produce cars, to put the world on affordable wheels. But he did not quite get the concept to work. Henry Ford did, working on the foundation laid by Olds.

In the early 1900s, Henry Ford unlocked the key to mass producing cars—designing parts to be interchangeable. Prior to that, each part was sized and shaped—by trimming and pounding—for one particular car. The part fit with the other parts that had already been fitted into that car. It might not fit another car. Ford insisted that each part be made to a specified design. Then it could be used in any car, without special fitting.

That sounds like a small improvement. In fact, it was a big one. More than the assembly line, mass production depends on having parts that are interchangeable. Ford's insistence that parts be standard and conform to a specification was probably his greatest contribution to manufacturing.

In Ford's factory, a skilled engineer needed to design each part, but unskilled labor could make the part. No experienced craftsmen were needed for that. And since each part was interchangeable, unskilled labor could be used to put the parts together. Parts could be even be made in a different factory owned by a different company, a car parts supplier.

Even for Ford, perfecting the process took time. Ford invented an improved assembly line, installing the first conveyor belt-based assembly line in Ford's Highland Park, Mich. plant in 1913. This assembly line reduced production cost by reducing assembly time. Ford's famous Model T took only 93 minutes to assemble.

Mass production made carmaking faster, cheaper, and more reliable. These cars were not works of art—the very simple design of the Model T was pedestrian. But they worked better and more reliably than the craft-produced cars that preceded them.

With mass production, scale became massive. Ford's River Rouge plant in Detroit employed 75,000 people when it reached scale in 1927. Raw materials like iron ore, coal, sand, rubber, and chemicals (shipped from Ford-owned mines and plantations on Ford-owned ships and trains) came in the plant. Finished cars drove out. Running vehicles were the only product that came out of the plant.

3. Lean (“Just in Time”) Production

But mass production had its problems. With its massive scale, mass producing cars took a lot of money and a lot of time to gear up before a single car could be made. Big factories had to be built and staffed. Complex designs had to be drafted, tested, and put into production. Capital costs were staggering. Only the biggest companies could afford this. Smaller companies faced big barriers barring entry.

In the mid-1900s, Japanese carmakers struggled to compete. The Japanese economy had been devastated by World War II. Japanese carmakers had a tough time making cars and light trucks, and when they did make them, buyers were scarce. Then orders from the American military forces fighting in neighboring Korea gave a jumpstart to Japanese carmaking. Toyota, in particular, built its business on sales to the American military.

Henry Ford's version of mass production—which Toyota studied—did everything in house. But Toyota found it impossible to do all the things in house that Ford was doing in its huge River Rouge plant. Even as it found its feet after the Korean War, in post-war Japan Toyota could not afford the capital it would cost to build that kind of scale.

Unable to match the huge scale of the American carmakers, Toyota had to do things differently. It had to lean on its suppliers for help. It had to keep inventories down. And it had to move nimbly to quickly change one of its factories from making one model of a car to another model.

So Toyota developed the “just in time” inventory system and quick assembly line changeovers that are core principles of lean production. Other Japanese carmakers took a similar approach. As the Japanese carmakers moved ahead, Ford and GM learned from them how to make cars both cheaper and better. Those principles have made their way into carmaker's factories around the world.

4. The Future: Modularity

The next advance in carmaking will, I think, be modularity. A modular approach can replace mass production with mass customization. Customized cars can sell at mass-production prices. By making standard modules that can be mixed and matched, a great variety of products can easily be assembled.

Carmakers already heard the siren call of modular production. Most of them have experimented, in a very modest way, with what they called “modular production.” (In fact, these carmakers were just building “subassemblies,” not true modules. What carmakers have done to date is different from the modular design, production and use I propose.)

Even these modest attempts failed, as the unions killed subassembly projects in the United States. GM's Yellowstone project was designed as a first experiment in how to benefit from building subassemblies. The project went down in flames, burning all the GM managers involved.

As a result, in one GM executive's words: “The word modular is no longer in GM's vocabulary.” Another GM executive was blunter: “‘Modular’ is the ‘m-word’ at GM.” For various reasons, including how hard it is to do modular production of tightly integrated cars, carmakers have turned away from modular production.

Modular is no “m-word” for me. Rather, to me modularity is fundamental. Modular design, production and use can be done separately or together to transform carmaking.

Let's see how.

### C. BASICS OF MODULARITY

In their book “Design Rules: The Power of Modularity,” professor Carliss Baldwin and then-dean Kim Clark of the Harvard Business School took a careful look at the computer industry. They wanted to find out why it was so successful. Their answer? Modularity.

Their book, published by MIT Press in 2000, has been far from a best seller. Yet it remains the seminal work on how modularity powered the computer industry to, arguably, replace carmaking as the “industry of industries” in today's world.

Modularity can mean a lot of different things. Some think of “plug and play” computer components when they think of modularity. Or they think of the production of subassemblies like GM did with its Yellowstone project. But modularity is not that.

Modularity is important to my invention. So let's take a careful look at its basic principles. Baldwin and Clark point out that a complex product like a car can be modular in one or more of three ways: design, production, or use. Here is an outline of how modular design, production and use work.

1. Modular Design

Modular design begins with architecture. A product can have a modular design if its basic functions have been separated into “black boxes” designed to be connected together. Using the term “black box” to refer to a module means that you care “what” the module does, but you do not care “how” it does it.

What tells you what the module does? Its specifications, or “design rules.” As long as you follow those design rules, you have complete freedom in designing how each module performs its function. You can then design the whole, complex product from these smaller systems, designed independently, yet all functioning together as a whole. That is modular design.

Computers give us a good example of a modular product. A typical desktop computer has software, case, processor/motherboard, memory, hard drive, monitor, keyboard and mouse. All of those modules have been designed to work together. So any one of those modules can be bought from any supplier, but it will still work with the other modules. Many sellers—like Dell for instance—do not themselves make any part of the computers they sell.

Design rules address both architecture and interfaces. Architecture rules tell what modules will be part of the product, and what each module's role will be. Interface rules give a detailed description of how each module will interact with other modules, and how the modules will connect and communicate.

Why do modular design? One big reason—modular design allows design work on different functions to proceed independently. A separate team of designers can work on each module, working independently and in parallel. That usually speeds up design work tremendously. There are other advantages to modular design, and some disadvantages as well. I will talk about some of those later.

To do modular design, then, you split up all the basic functions of a complex product into separate modules. You then define the interfaces between modules, which gives you the design rules that designers need to follow. Each module designer, or design team, then freely designs its own module, limited only by the design rules.

2. Modular Production

Modular production also requires splitting up a complex product into modules. If the product has been designed in modules, producing modules is easy. Even if the product has not been designed in modules, though, you can still do modular production. It's just harder.

Note here, though, that making subassemblies, like carmakers sometimes do, is not modular production the way I view it. Carmakers, for example, sometimes make different components of a car at different sites—like a “rolling chassis” for a pickup truck—and then bring them together for final assembly. That's just taking part of an integrated design and assembling it separately.

Modular production requires splitting up a product into black-box modules and specifying interfaces. How the module maker makes the module is its business. As long as the module maker delivers a module that meets the required specifications, the process works. Here again, each module maker freely makes its own module, limited only by the design rules.

3. Modular Use

Modular use is “mix and match.” It lets consumers mix and match modules to come up with their own version of a final product. In their book Design Rules, Baldwin and Clark give the bed as an example of modular use.

Most of us buy (often at different times) bed frames, mattresses, pillows, sheets, blankets, and bedspreads made by different makers and sold by different stores. We can do that because we can trust that the various parts will fit together. (Usually.)

The parts, or modules, fit together because they are made to standard sizes—single, double, queen, and king. (Most countries have four mattress sizes, although the sizes and names tend to differ a bit between countries.) The dimensions for the various modules in standard sizes are the design rules for modular use. Those design rules are binding on designers, makers, sellers, and users.

Within those design rules, a bed sheet buyer can choose a sheet made from a costly material like silk or a cheaper material like cotton. Put the sheets together with pillows, other bedding, bed frame, and mattress and you have a bed ready to sleep on. Each module user freely uses the module in the final product, limited only by the design rules.

4. Mass Customizing

Modularity in design, production and use can give consumers “mass customized” products. That is, a highly customized product offered at a mass production price. “Mass customized” goes in quotation marks here because it's usually an oxymoron. No one expects custom products at cheap prices. You can buy a suit off the rack cheaper than you can have a suit custom made by a tailor.

Modularity can help change that, so we can get custom products at mass production prices. How? Let's look at one example to see how it works. Take the example of a car.

Right now, carmakers only make and sell complete cars. So any customization must take place on an assembly line. That's a problem, because assembly lines get the efficiency they do by churning out copy after copy of the same car. Making any change from car to car slows down the process, increasing costs.

Carmakers do offer different “factory options” to their customers. Some carmakers have done this fairly well, allowing different choices in color, type of seat, air conditioning systems, and the like without increasing cost much. In fact, one carmaker brags that it can produce one car model in any of a million versions, just by choosing among the various factory options it offers.

But these factory options are usually nothing big. You cannot put a Ford Mustang body on a Toyota Camry chassis. Or even slot Jaguar seats in a Honda Accord. You get choices, true, but they are things like paint color or type of seat fabric. The car you get is still the same basic car.

Carmakers cannot make two really different cars, one after the other, on the same assembly line. They need economies of scale to get mass production prices. Custom products cannot be made in scale on an assembly line.

That changes when you have module options. That is, when you do not make complete cars but instead make car modules that can be combined later. Then you can get very different cars out of an assembly line process, with its economies of scale. You get mass customization.

To see how that works, let's look at a car that has seven modules: a car operating system, driver control unit, wheel/motors, motor controls, power unit, car body, and car chassis. Each module is designed and made, according to design rules, so that it can be combined with the other six modules into a car.

Let's assume that together the various carmakers offer 6 versions of each of the 7 modules. Even with that modest assumption (carmakers would probably offer more versions), a car buyer gets a lot of choice just from this, with 279,936 different combinations to choose from. (FIG. 3 shows this example.)

Of course, having to choose from 279,936 different combinations will not thrill anyone. No one wants that—choice of that magnitude paralyzes. But here one only has to make 7 choices. With 7 choices you are selecting from 279,936 very different combinations. That's the beauty of it. That's mass customization.

5. The Power of Modularity

Modularity can be powerful. Evolution in today's car industry happens slowly, like with tortoises having a life span of 100 years. With modularity, evolution and innovation speed up. Technologies advance in parallel. Ideas breed like hares. Maybe even like fruit flies. Innovations can come to market much quicker in a modular industry.

A couple of examples of how that might work. First, Michelin has been developing a new concept called the “tweel” (a combination of a tire and a wheel). Instead of a tire filled with air, the tweel has spokes that can bend and spring back. Now Michelin has to find a carmaker to design the tweel into a car. The tweel might come to market more quickly if it could be designed to standard design rules for any car on the road.

The second example comes from Australia. A small company there has a new approach that could be used for a power unit. Their free-piston linear generator design has lots of potential. The pistons have no rods attached. Instead, they have magnets in them. As the magnets move back and forth inside wire-wrapped cylinders, electricity is generated.

What if this free-piston engine could go as a power unit in any car? Without needing to be selected by a carmaker for one of its future models? It could then be on the market much more quickly.

To be a player in carmaking, even a major player, a company will not need to master every technology that goes into a modular car. My modular approach lets the modules from one module maker work with other top technologies from around the world, all combined into a car. No one needs to reinvent the wheel. Or any other part of the car.

Modularity—using modular design, production and use—in carmaking can transform the industry.

### D. HOW A MODULAR CAR MIGHT WORK

To get a detailed idea of how a modular car might work, look at my patent application called “A truly electric car.” Here, I will describe just the basics, as shown in FIG. 4, of how a modular car might work.

First, though, one key point. Many think that the gasoline-powered cars we have today are, sometimes and in a modest way, modular in design and production. They might even consider some parts of today's cars—car tires, batteries, navigation systems, car music players—to be modular in use. But that's not the kind of modularity I'm talking about. Modularity does not power carmaking today.

There is a reason for that. A gasoline car cannot easily be separated into three or more independent, “black box” modules. A gasoline car tends to be tightly integrated, built around the engine and steering wheel. An electric car, by contrast, can easily be separated into “black box” modules. That sets the full power of modularity free to work.

The modular car in my example has seven modules:
car operating system
driver control unit
wheel/motors
motor controls
power unit
car body
car chassis

Each module is a largely independent “black box,” with connections (often called interfaces) to other modules. Each module can have sub-modules within it. Each module has three kinds of connection to at least one other module:
data
power
mechanical

Data connections are through a data bus (or buses). Power connections use a power bus (or buses). The car body's connection to the chassis is the most important mechanical connection. FIG. 4 shows each module's data, power and mechanical connections to at least one other module.

My “A truly electric car” patent application has a more detailed discussion of the connections (or interfaces) between modules, as well as the modules themselves. Here I will just briefly describe how the seven modules work.

1. Car Operating System

The car operating system (hardware and software) is the car's nervous system. It runs the car. For its brain, the car operating system has high-end hardware and sophisticated software. For its nerves, it has data buses. The main task for the car operating system is to let the driver control the car. Basic steering, braking and accelerating. FIG. 6 shows how this might work.

The car operating system software can also do many things that a mechanical car needs special hardware to do. Electronic stability control, for example, becomes software only. Four-wheel drive does as well. That's true four-wheel drive, where one wheel can turn in reverse while another wheel turns forward.

The car operating system will also need to manage the car's use of energy. With electric cars, the days when cars have power to burn are gone. Energy parsimony rules. Centralizing the car's energy management in the car operating system will make economic use of energy easier.

Finally, as cars get more complex, the car operating system needs to get more complex as well. Handling all the demands for power and data—from entertainment systems, heating and air conditioning, navigation systems, telephones and other devices—will keep the car operating system busy.

2. Driver Control Unit

The car's driver uses the driver control unit to drive the car. Good drive-by-wire systems—like a joystick made by Mercedes and a steering yoke made by SKF—have been developed that work well with a modular car. Or a standard steering wheel and brake and accelerator pedals can be made electronic. In fact, on many of the more expensive cars, they already are.

Steering, braking and accelerating are a given. But the driver control unit needs to handle more than just those simple interactions between driver and car. The car must also give information to the driver. That could be done by having one screen that can shift between a speedometer, fuel tank gauge, or navigation gauge. A heads-up display on the car windshield might also work, particularly for some drivers who like that look.

Most driver controls today have evolved little over the years. Some carmakers have tried to do things differently. Mercedes had a bad experience with a controller that controlled a variety of car functions. The controller was too different, and complicated, for most people. People found it hard to use. Designing simple human-machine interaction is not simple. It's hard.

In fact, a field of study called “human machine interface” (HMI) has evolved to do this better. Companies like Nintendo (with its innovative Wii controller for video games) might have an advantage in this area over car companies. Or maybe not. It will be interesting to see who can provide the easiest driver control units to use.

3. Wheel/Motors

The wheels and motors together make up a module. Powerful, light motors might even fit in the wheels themselves, as wheel motors. If unsprung mass in the wheel poses too many problems, motor modules could be “near wheel” rather than “in wheel.”

There could even be a central motor connected to the front or back wheels of the car with a normal transmission. The motor and transmission might then need to be part of the chassis module, making the car more integrated and less modular.

4. Motor Controls

The motor controls provide the electrical signals to drive the motors. The motor control could be software based. That is, a software program could shape the current that goes to the motor.

Of course, high-power transistors actually shape the current, usually using a process called pulse-width modulation, as it is drawn from the power module. So some hardware would be needed. But software would create the signal switching the transistors on and off. That gives a lot of flexibility—upgrades become easier—and improves the economics.

More than the other modules of the modular car, the motors and motor controls need to be designed to be interoperable. That is, the motor control needs to provide a signal to the motor that reflects the particular architecture of the motor.

5. Power Unit

The power unit provides electrical power to the electric motors, and to other electric devices in the car. Electrical power can be had throughout the car from power buses. The electrical power can come from a bank of batteries. Or from an electrical generator powered by a gasoline engine. Or from a combination of both, such as in a plug-in hybrid.

In addition to electrical power, the power unit provides heat energy to heat the interior of the car, for passenger comfort. The heat might be waste heat (from a gasoline generator), or from a special propane heater, or even by running electricity through a heat coil. The car body unit has the ducting to move the heat around, but the power unit provides it.

I expect a lot of creativity—plug-in hybrids, cars powered in part by the sun, advanced regenerative braking—to go into the design of the power unit once it becomes a black box module that allows for experimentation. Battery makers, carmakers, generator makers, supercapacitor makers, maybe even fuel cell makers, might all be interested in trying to make this module.

6. Car Body

The car body has the seats, the doors, the windows, and the other things that make up most of what we think of as the car. The car body focuses on passenger safety and comfort, but also fashion and attractiveness. Careful engineering is needed to divide the body and chassis into separate modules, without adding too much weight and cost.

Today's carmakers will probably do best at making car body modules. They have the factories to stamp the steel, weld it, paint it, and put all the components of the body together. But other companies that have experience in making specialized, low-volume car bodies (perhaps a company like Lotus) might find that their skills make them better at this.

If so, carbon fiber might replace steel in the basic shell of the car body. Aerodynamics (reducing drag, and maybe even changing the shape of the car as speed increases) should become more important. And human nature being what it is, the design of the car—the fashion statement it makes—will always be very important.

7. Car Chassis

The car chassis includes systems for steering, suspension, and braking. Ideally, these are electrical systems rather than hydraulic. The car body and car chassis need to work well together, with minimal noise, vibration and harshness. For that reason, some module makers will probably offer a combined car body/car chassis module to start. That will be fine with me. Whatever works best.

The car chassis is the base on which most other modules sit. The car body, of course, sits on the car chassis. So does the power unit. The wheel/motors connect onto the chassis. The motor controls also sit on the car chassis, close to the wheel/motors.

Some of the tier-one parts suppliers like Dana have designed and built chassis for pickup trucks that do not have a “unibody” construction. That kind of chassis might be easy to convert to a black box module that meets the design rules for my car design.

### E. CARMAKING IN CRISIS

As one car industry executive put it a few years ago: “The fun has gone out of what should be the most exciting industry on the planet.” That might be an understatement. At the start of its second century, the car industry is not just an unhappy place. It's a disaster. Carmaking has caught nearly all the diseases that can afflict an industry. Two of America's Big Three might well have terminal cases.

If that were not enough, the car industry has its own special afflictions—shrinking supplies of oil, concern about greenhouse gases and pollutants, the perceived need for energy security or, ideally, energy independence. Those problems would challenge even a healthy industry. They might kill a sick one.

The list of symptoms American carmakers suffer from is a long one:
a few huge carmakers “too big to fail”
bankrupt makers and suppliers
unrealistic labor/management deals
heavy healthcare and pension burdens
pressure to deal with pollution, global warming, oil depletion and energy security
government regulation and meddling
financial bailouts
chronic overcapacity in factories and workforce
vast parking lots filled with unsold cars
financing overhead
no direct customers, with dealers in the middle
too many dealers, all protected by state law
lawsuits
layoffs
huge fixed costs
strong labor unions
sad (and deteriorating) balance sheets
fierce competition
commodity pricing
poor profit margins (or lately just plain losses)
unhappy dealers
unhappy customers
long waits for popular models
skittish shareholders
duped bondholders
soaring development and marketing costs
no-growth (even declining) markets in North America, Europe and Japan

Some think that, for the American “Big Three” carmakers at least, these diseases might be fatal. Count Carlos Ghosn, the CEO of Renault and Nissan, among them. In a prescient Jan. 28, 2008 interview with the Wall Street Journal, Ghosn said that not all of the Big Three could survive, “but whether there is going to be one left or two left or none left I don't know.”

Let's look at some of these car industry problems, particularly those of the American Big Three carmakers, in detail.

1. Global Warming and Oil Depletion

Some think that global warming and oil depletion (including energy security) pose the biggest challenges of our generation. Others are more confident, thinking these problems have been blown out of proportion. But more and more, people worry.

As people worry, they tend to blame carmakers for the problems. Carmakers are cast as villains, whether they deserve that role or not. Congress recently (in 2008) forced carmakers to increase the fuel efficiency of their cars by 2020. Carmakers have been hauled into court by the state of California, which claims their cars cause harmful global warming. Pressure from government on carmakers will intensify, not ease.

The Detroit Big Three, clearly sick and possibly dying, have little left to battle these new problems. Rising temperatures and rising gasoline prices hurt the American people, and these problems get attention. Global warming and oil depletion add to the carmakers' woes, and might claim the carmakers as their victims.

2. Layoffs and Labor Unions

America's strongest unions in recent decades have probably been in carmaking. Whether strong labor unions are good or bad can be debated. Arguments are made on both sides. But the benefits of strong labor unions go to union members, not to the companies that employ them. Strong labor unions clearly add to the carmakers' illness.

Carmakers have laid off employees for years. If you read the newspapers much, you would think by now that the Big Three in Detroit would not have any workers left. Certainly layoffs go in cycles, with some hiring back in between. But there is no question that many Detroit carmaking jobs have gone, and are not coming back. The economy in Detroit hurts because of it.

One reason for layoffs is chronic overcapacity in carmaking. Existing Big Three factories in the United States normally average less than 70% of capacity. Carmakers can build a lot more cars than they can sell. In the United States market, the number of cars sold peaked a few years ago. The number has gone down since. (In late 2008/early 2009, the number tumbled, perhaps permanently.) Layoffs will continue.

In any industry, layoffs will happen from time to time. In spite of the damage they do to families, layoffs can be healthy for an industry. The American car industry's chronic layoffs are far from healthy. They are a sign of disease.

3. Horrible Financials

Carmakers have horrible financials. And they are getting worse, not better. Of course, the Big Three do not all share the same financial problems. Their balance sheets differ. Ford, for example, has a huge amount of debt. GM and Chrysler, as of Jun. 1, 2009, are both in bankruptcy.

Anyone who has looked at a lot of balance sheets would not like what they see on any of the Big Three's balance sheets. Like an electrocardiogram will often show best the true health of a heart, a balance sheet will often show best the true health of a company. The American carmakers are sick.

Many of the companies that supply the Big Three carmakers have financial problems of their own. The Big Three relentlessly push their suppliers on price. Those suppliers who cannot cut their prices and stay in business will be cut loose. One way or another, they are out. With a few impressive exceptions (like tier-one supplier Magna), Detroit has become dismal for carmakers and their suppliers, up and down the line.

Shareholders and bondholders have become skittish. Too much money has been lost. Few view any companies in the car industry as having good investment potential, and for good reason. Car companies will need to do much better, for a fairly long period of time, before shareholders will change their views.

4. Commodity Pricing

Carmakers compete fiercely, and around the globe. Some put global carmaking capacity at 90 million cars. Even in good times, global new car sales peaked at 60 million cars. (The 2009 figures are expected to be below that.) Almost every carmaker could make more cars, at a reasonable marginal cost, than it can sell. Most do.

Carmakers build cars based on forecasts, and the forecasts are always too optimistic. So carmakers are stuck with cars that they have already built, but can sell only by slashing prices. Discounts and incentives get “put on the hood” of every car to make the sale. This fierce competition breeds the disease of commodity pricing. That disease won't kill an industry. But it will doom it to low margins and losses rather than profits.

Some think that no American carmaker has made a profit on its passenger cars for a decade. If that is true, commodity pricing may be to blame.

5. Fewer Buyers

Car buyers tend to be unhappy customers. Rarely do they get what they really want. Car salespeople (mostly men) largely deserve their poor reputation. They use high-pressure sales techniques. They trick buyers. They do everything they can to make a sale now, and they worry not at all about treating a buyer nicely so he or she will return in the future. That is the way the car business works, in the United States at least.

Carmakers do not help. Rather than provide customers with the car they want, they ship cars to dealers and provide incentives so that the dealer pushes what it has on to customers. (FIG. 1 shows how this works for a hybrid electric car.) Typically, car buyers cannot get exactly the car they want. They have to settle. Customer loyalty, for the most part, is only as strong as the price.

Economics and a mature market combine with stable or declining populations to make carmakers face no-growth markets in North America, Europe and Japan. The growth trend spiked downward in 2008 and 2009. That hurt. The damage done might be permanent.

Industries with no growth face financial challenges that growing industries do not. A rising tide lifts all boats. An ebbing tide lowers them. Carmakers are being lowered by the ebbing tide of car sales.

### F. WHY MODULARITY IN CARMAKING?

The current limitation of carmakers in America to the “Big Three” hides one fact. The Big Three are huge companies. But carmaking began with many small companies fighting fiercely to survive. The same kind of strong-willed inventors and risk-tolerant venture capitalists who later would build the computer industry. Carmaking can, I think, return to its roots, and then grow to be more like the innovative, vibrant, profitable computer industry.

So enough with carmaking's problems. Let's look at a possible solution. Modularity in carmaking should help the car industry, from carmakers to parts suppliers to car dealers to car buyers. I think everyone will benefit.

In theory, we can easily separate modularity into modular design, modular production, and modular use. The separation is harder in real life. So let's look just in general at some of the advantages modularity—whether in design, production or use—might bring to carmaking. Possible advantages are many. These are just a few.

1. Horizontal Industry, Not Vertical

With a modular industry, carmaking might become one of the most innovative, vibrant and profitable industries in the world. How? By changing the industry from a vertical industry to a horizontal industry.

Take the computer industry as an example. Intel's Andy Grove in his book Only the Paranoid Survive described how the computer industry had once been very vertical, dominated by a few companies he called “vertical stacks.” The first chart in FIG. 2(a) shows that graphically.

In the 1960s, the computer industry was just “Snow White and the seven dwarfs.” IBM, the largest by far, was Snow White. The others were the dwarfs: Burroughs, Univac, NCR, Control Data, GE, RCA and Honeywell.

In the 1970s, GE sold its computer business to Honeywell. RCA sold its to Univac. No longer seven dwarfs, the small firms became known as “the BUNCH” (Burroughs, Univac, NCR, Control Data and Honeywell). That, IBM and the BUNCH, was pretty much the computer industry.

With modularity, that changed. In 1996 when Andy Grove wrote his book, the trend toward horizontal companies had started. Since then it has increased. Number of companies exploded. So did market capitalizations. Updating his second chart a bit gives the second chart in FIG. 2(a).

Many new companies have entered the computing industry: Microsoft, Intel, Oracle, Google, Dell. Many have come and gone, like Silicon Graphics and Wang. But as a whole the industry has been vibrant. Even as the slivers of the industry pie get smaller for each company, the size of the overall pie gets so much bigger that most have a larger share.

These two charts show how complete the shift was from a vertical to a horizontal industry. That caused steep increases in innovation (the so-called Moore's Law, for example), new entrants, and the total market capitalization of the companies in the industry.

By contrast, the car industry changed some, but not much, over the years from 1980 to 2000. The industry, particularly in the United States, is dominated by the same “vertical stack” carmakers now as then. Innovation, new entrants, and total market capitalization have stagnated. Potential for profits in the car industry are not good.

The car industry should shift to making cars with modular design, production and use. It may then rival, or even overtake, the computer industry in its allure to creative people, companies, and investors. In 20 years, a chart of the industry will show great improvement. (Might it become like FIG. 2(b)?)

Many other new industries can also develop—home ethanol plants, solar cell car ceiling fans, propane heating systems, transportation networks. Like the computer industry before it, the car industry might change dramatically in two or three decades. In 1980, who would have thought that Internet companies would come to be such a big part of the computer industry? No one.

Of course, the car industry is not the computer industry. But if the history of the computer industry offers a reliable guide, the car industry will become less vertical and more horizontal as two things happen: (1) Modular design, production and use increase. (2) Venture capital becomes available companies that make modules.

Modularity can make carmaking a horizontal industry that is innovative, vibrant and profitable. Given the car industry's multi-trillion dollar size, that might give the world's economies a big boost.

2. More Players but More Profit

Carmakers now sell only complete cars. Few sell parts or technologies to each other. Some carmakers target a fairly specific market, like Porsche with its high-performance, high-price cars. But there is little specialization among carmakers, where a carmaker dominates a part of the industry and sells technology or systems to other carmakers.

Modularity can change that. A company like Honda might focus on motors. With its strength in complex parallel hybrid controls, Toyota might focus on car operating systems. That kind of specialization, so strong in the computer industry, would bring a fresh look to the car industry, and might bring new vigor with it.

Most industries tend to spawn at least one very profitable niche that yields more profits than the rest of the industry. American Airlines long made more money from licensing its Sabre electronic reservation system to other airlines than the whole airline industry made from selling seats on flights. Regional phone companies once made more money from their yellow pages than from phone service. At its peak, TV Guide made more money than any television network.

The car industry too has its niches. The finance arms of the Big Three often made more profits than their car-selling counterparts. And for the past decade, sales of sports utility vehicles and minivans have generated profits while sales of passenger cars have generated losses. A carmaker that made only sports utility vehicles would have had a very nice business, with good margins.

But it has been very hard to isolate the profitable parts of the industry from the ailing parts. So the weak dragged down the strong. All suffered together.

Modularity lets carmakers focus more tightly on profitable niches in the car industry. Italian carmakers, for example, might focus on overall design of car body modules. Their proven skill in this area makes them likely to post profits if they can sell just this module. Their lack of skill in the complete car market would no longer keep them from competing at all.

By creating more niches, modularity will let more companies enter carmaking. Not all will see success, of course. But the car industry should see a lot more companies grow strong and profitable than now, just as happened in the company industry.

Even with more companies competing in the industry, modularity can bring profits to carmaking. Software-type profit margins—unheard of in carmaking—will be available to some. Those profits will come from making features (like four-wheel drive and motor controls) in software rather than hardware. With software, perfect copies can be made at almost no cost, so gross profit margins soar.

Even car parts still made in hardware can make more profit. When a car dealer can sell more desired options on a car, most sales yield more profit. People pay well for what they want. When you use “incentives” like rebates and price cuts to force them to settle for the car you are pushing, you need to cut the price. Mass customization lets you focus on features, not price. That pleases both car buyers and car dealers.

The computer industry shows how profit margins can rise even as an industry becomes more competitive. Companies in the computer industry with new technology can often charge a “technology premium.” Those with more stale technology need to cut costs. In an innovative and growing industry, more companies can find a way to make money than in a stagnant and shrinking industry like carmaking today.

3. No Need for Big Incentives or Full Floorplan Financing

With modularity, discounts might no longer be needed to move cars that have been sitting on a car lot for months (or years). Or to compensate for a car that does not have the specifications that the car buyer really wanted. Today's car buyer in the United States has come to expect “incentives” like discounts, rebates and below-cost financing. They have become essential to sell cars. Once modularity comes to the car industry, discounts will no longer be essential.

One big cost car dealers face is financing inventory. A car dealer must pay the carmaker for a car when it is delivered, not when it is sold. Most car dealers finance their inventory through a bank using “floorplan financing.” The car dealer borrows the money to pay the carmaker for a car it receives. The car dealer pays interest on the loan until it sells the car to a buyer and pays off the loan. That can take months.

Anyone who spends a lot of time on urban and suburban roads will probably pass a car dealer lot every now and then. They will usually see fields of unsold cars on the dealer landscape. Adding up the cars sitting unsold across the United States probably gives a number in the hundreds of thousands. That costs car dealers millions of dollars a year, cutting margins heavily.

Modularity should change that. Cars can be built to order, and will be paid for when delivered. Car dealers then would not need to finance inventory, since the car would be ordered only when paid for. Carmakers would also benefit. The carmaker could order modules from suppliers only when the carmaker has a paid order for a car. Like Dell does with computers, carmakers would then be getting their suppliers to finance their inventory.

4. Everyone Gets a “One of a Kind” Car

“There is only one boss—the customer. And he can fire everybody in the company from the chairman on down, simply by spending his money somewhere else.”

Sam Walton

“The real bosses, in the capitalist system of market economy, are the consumers. They, by their buying and by their abstention from buying, decide who should own the capital and run the plants. They determine what should be produced and in what quantity and quality. Their attitudes result either in profit or in loss for the enterprises. They make poor men rich and rich men poor. They are no easy bosses. They are full of whims and fancies, changeable and unpredictable. They do not care a whit for past merit. As soon as something is offered to them that they like better or that is cheaper, they desert their old purveyors. With them nothing counts more than their own satisfaction. They bother neither about the vested interest of capitalists nor about the fate of the workers who lose their jobs if, as consumers, they no longer buy what they used to buy.”

Ludwig von Mises

The great thing about mass production is that it can bring one standard product to millions of people with unmatchable efficiency. But it cannot do the opposite—bring a million unique cars to one person each. Yet that is exactly what mass customization does.

We consumers make markets work. We buy based on many things, often emotion more than logic. Important as appealing to consumers is, trying to anticipate fads and fashion has bankrupted many a company. The Ford Edsel still stands as a strong lesson in how marketers' predictions about consumer appeal cannot be trusted.

With mass customization, carmakers can make a “one of a kind” car for every car buyer. Modular options allow a lot of customization even while the price remains a mass production price. A carmaker can cater to the tastes of a market of one, giving each car buyer exactly what they want in their car, or at least what they will pay for.

Build to order helps. With modularity, cars can be built to order more quickly. The Big Three all can, and do, build cars to order. But few car buyers in the United States want to wait the weeks or months that it takes for a built-to-order car to arrive. We do not seem to have the patience that many car buyers in Europe have, where a good quarter of the cars sold are built to order and delivered only after a fairly lengthy wait.

Making built-to-order cars more attractive gives benefits to car buyers and car dealers alike. Car buyers like getting the car they really want. They see themselves as getting better customer service. Car dealers no longer have redundant stock. Every car they sell will have been ordered by a buyer. A car dealer will not have to stock cars and wait for a buyer to select one that is in stock. Big benefits for car buyers and dealers both.

Modularity makes it easy to accommodate local variation. People may, for example, want to use different kinds of power modules depending on where they live. Batteries do not do well in cold weather. So a power module powered by a gasoline generator might do better than batteries in the Canadian plains and Minnesota. Battery-based power modules might do fine, though, through the winter in states like California and Arizona.

Other variations in power modules might depend on local electrical power supplies. Hawaii, for example, generates most of its electricity from petroleum. There might be little benefit to using batteries to power cars in Honolulu. Better to get electricity from an on-board gasoline generator. Idaho, though, gets its electricity from hydropower. Battery-based power modules make sense there.

States that depend on coal for electricity might also benefit from using high-efficiency gasoline generators in cars rather than batteries. Other countries will have their own issues as well. Gasoline costs a lot across Europe. Electricity, by contrast, can be relatively clean and cheap in France (with nuclear power) and Norway (with hydropower). Both gasoline and electricity cost a lot in Japan. It all depends. Having options helps.

5. More Design Freedom

Modular design partitions the design of a complex product into parameters that are visible—the design rules and interfaces—and parameters that are hidden inside a black box. Hidden design parameters are isolated from other parts of the design. So they can vary. To the designers of other modules, the values of the hidden parameters can be uncertain. They lie inside a black box.

That uncertainty lets a module designer experiment within his or her own black box module. Anything can be in the black box, as long as it works. If new knowledge yields a better solution for the module design, that new design can be used without changing the rest of the system. Design freedom increases.

This approach goes against the grain. We like the familiar approach of building on the old to make the new, making incremental changes. If one writes a new budget for a government lab, for example, one makes slight adjustments to last year's budget. One doesn't start from scratch. A car is the same way. We can change only so much without jeopardizing the whole. Yet if we start from scratch, we abandon too much.

A modular car frees us—almost forces us—to try new ideas. If we do not push the limits of the possible, someone else will, and we will lose. With fast design evolution, complex changes in an industry can occur. (Maybe even a change as big as this—carmaking becoming innovative, vibrant and profitable.)

One of the biggest advantages of modularity is that designers have more freedom—within the design rule constraints—to experiment. That will result in more choice at the extremes. Not just the same “me too” designs of most cars. A wider range of more varied choices will let designers find a niche within their market where they appeal to consumers.

That cannot happen when designers need to design a complex product like a car as an integrated whole. Then designers have an incentive to choose low-risk, low-reward options in making each design choice. Experiments with high-risk, high-reward options never occur.

Why is that? Designing the car is a long, complicated effort made by teams building sequentially on the efforts of others. Any failure along the way will cause delay. Failures will sometimes require that the project start over. So no one can afford to experiment with high-risk, high-reward options. The cost of failure is too great to take high risks. Choosing a low-risk option every time a choice is made will best ensure that the final product is a success.

That is particularly the case with safety. No carmaker can put people's safety at risk. The government regulates them, for one thing. For another, carmakers get sued all the time. They pay big bucks to lawyers and, in many cases, to plaintiffs. The best way to avoid problems is to do what the government requires, no more and no less. And to do what every other carmaker does, no more and no less. No one tries anything new to increase safety. They move as a herd.

Safety has suffered. One car industry manager note, as he watched new cars coming off an assembly line, “Just think, more than one out of three of these cars will have blood on them.” Cars kill the young more, proportionally, than the old. That means that more life expectancy is lost to car crashes than to cancer or heart disease.

Modularity might help with that problem. Modular designs can be tailor-made to fit particular buyers. There are some problems with that—it is not going to suddenly become heaven on earth for carmakers and car buyers. But the design freedom that comes with modular cars will help safety and other innovations develop.

6. Intellectual Property Gains Value

Modular design makes intellectual property gain in value. That is because a patent can cover a fairly broad function of a car, as defined by a module. Car-related patents will not be limited to smaller components or limited functions, as they are now. As innovation increases, so will intellectual property gain in value.

Of course, car companies do have patents. Some of them are quite valuable. Toyota's Hybrid Synergy Drive, for example. Toyota developed and patented parallel-hybrid technology for its Prius and other hybrid cars. Other car companies decided licensing Toyota's hybrid technology was cheaper than developing their own.

Valuable car patents, though, are the rare exception rather than the rule. Most car company patent portfolios have little value. At least, little value compared to the portfolios of companies in more high-tech industries, like semiconductors or pharmaceuticals.

The fact that patent peace tends to reign in the car industry rather than the patent wars in, say, the computer industry reinforces that view. The car industry has never seen, for example, the kind of epic battle that Fujitsu and Texas Instruments fought in the Japanese courts in the 1990s over the Kilby integrated circuit patent. With modularity, in the future it may.

7. Carmakers can Focus on Brand, and Forget Factories

Modularity lets carmakers focus on brand, and forget factories. Cars are complex—perhaps the most complex product people buy. A car has 10,000 parts. Thousands of engineering decisions go into producing hundreds of different makes and models of each. Each car model has its own handling, performance, features, and costs.

But when it is time to buy a new car, do you really care? Do you study specifications and performance data? No. Not unless you are a car guy. Even then, you probably do not look at very many makes and models. You do not need to visit a variety of dealers—Chrysler, Rolls-Royce, Porsche, Lexus, Chevrolet and Volvo—to compare cars. You have an image in your mind of what kind of car to consider. That guides you to the handful of cars that you will consider.

So you choose a car based on what you already know. If you are like most people, that is not much. Almost all of us—millions of people—make the second-largest purchase in our lives based on strong opinions about something that we really know little about. We base our choice instead on something that marketers call “brand.”

Brand can mean a lot to buyers. Consumer products provide lots of examples. Cigarettes differ very little, whether they be Marlboros or Virginia Slims. Pepsi tastes the same as Coke. (Blindfolded taste-testing shows that no ordinary human can tell whether a particular cola is Pepsi or Coke.) We buy one product over the other based on their brands.

Carmakers have some of the most powerful brands in the world. With modular use, carmakers can more easily focus on their brands, selling image more than anything concrete. Things are already trending that way. Carmakers already make less and less of the cars they brand and sell. Modular use can accelerate that trend.

So with modularity, factory-less carmakers can become common. The same way “fabless” semiconductor makers transformed that industry, carmaking can also be transformed. That is, a carmaker can take a systems integrator role that lets them design the basic car, but lets them farm out the design and production of the modules of the car. Then have the modules assembled, again by someone else. Then have the cars shipped to car dealers for sale under the carmaker's brand.

In that case, the “carmaker” does not make anything. The carmaker concentrates on design and brand. That, rather than manufacturing, is where it makes money. The consumer electronics industry has done this for years. For example, Sony video cameras were once made under contract by Kyocera. The Sony cameras looked just like the Kyocera cameras on store shelves, except they said Sony on them rather than Kyocera. The only thing Sony contributed to the camera was the brand.

Factories require carmakers to invest a great deal of money, all up front, before they can turn out a single car. That limits the possibility of a carmaker starting out small and bootstrapping its way to be bigger. If carmakers do not need to build factories to build cars, that lowers the capital they require.

Lower capital costs also help new car companies find investors. Venture capital firms and private equity can find deals that, because less capital is required, fit the profile they are looking for. Silicon Valley-style startups might start to dot Detroit.

Modularity can accelerate these trends. That should change the car industry for the better.

8. Demand “Pulls” Production of Cars

We learn from a high-level look at economies that product “pull” works better than “push.” Command economies set production figures and push products in those numbers onto the market. Demand economies let consumers pull products from makers through market demand. Demand economies do better than command economies. Think of the Soviet economy compared to the American economy.

Industries tend to behave the same way. In the computer industry, for example, computer buyers tend to pull products onto the market. Demand rises? So does production. Demand falls? So does production. Problems happen, and mistakes are made. In general, though, supply and demand keep closely tied.

The car industry does not work as well. Typically production numbers get set by forecasters, who set the numbers just once for the whole model year. That number of cars is made and shipped to dealers. Dealers, working with carmakers, adjust prices and add incentives until all of the cars are sold. The cars are pushed onto the market.

Modularity can help. With a car split up into modules, making a complete product to sell (in this case a module is the complete product rather than a car) takes less time and less money. That puts the module maker closer to market moves, in a better position to match supply to demand.

Modularity also makes model changeover and design changes easier. That would help carmakers react more quickly, and with less expense, to changes in demand. The car body, in particular, will tend to change more with fashion than with function. Most people buy cars based on their bodies. That is what we see, and react to. What is under the hood might interest some, but not many.

Letting demand pull the production of new models will work better than the current forecast method carmakers use. Model changeover may, with modularity, mean just changing one module—the car body module—out of many. Demand can pull popular new car bodies onto the market. Dealer lots full of unpopular cars but empty of the popular ones may be a thing of the past.

Design changes will be easier as well. When one module changes design, if the design rules have not changed, no other module will need to change with it. In a tightly integrated car, design changes will affect other parts, often in unpredictable ways. In today's cars, design changes can be made only with care. Modularity makes design changes less trouble, and lets demand pull the changes.

9. Innovation and Manufacturing Speed Up

Carmaking is not known for the speed of its innovation. Needing to produce a tightly integrated machine, where all parts must work together, makes experimentation tough. No car will go to market unless all of its parts have been proven and tested, operating as a whole.

That slows innovation down. The DaimlerChrysler director of its “body and human-machine interaction” program said in 2004 that “The cars [we are working on] are innovations representing the future of motoring. We hope that they will all provide research platforms that one day will see the technology that we are using making it into production cars.”

How soon would that be? “These are automobiles of the day after tomorrow,” says Pletschen. He estimated that the technology would not hit the roads until 10 or 15 years later. And these were for technologies like drive-by-wire steering that bring little new to carmaking.

So compared to the pace of change in the computer industry—almost like careening down rapids in a river—the pace of change in the car industry can seem glacial. Innovation does occur. Year by year, cars become better—higher quality, more powerful, with new features. But the pace of change is anything but breathtaking. It's slow.

Carmaking innovation can be much faster. By isolating tasks, modularity increases the complexity that can be managed in a design. That reduces the cycling that occurs in the design of a complex thing. A designer can focus on an element or task in isolation, finish it, put it aside, and move on to the next element or task. Or teams can work on elements or tasks in parallel.

Without modularity, complex things can be very difficult to design. Interactions between tasks make the design process as hard as building a house of cards. As more and more tasks are finished, “cycling” makes the design process like adding cards to the top of the house of cards. As the next task is attempted, the whole thing often comes tumbling down. The cycle starts over. The house of cards must be rebuilt from the bottom up.

Frederick Brooks wrote in “The Mythical Man-Month” that “when a task cannot be partitioned because of sequential constraints, the application of more effort has no effect on the schedule. The bearing of a child takes nine months, no matter how many women are assigned.” Brooks gives his “Brooks's Law” as “adding manpower to a late software project makes it later.”

Modularity can change that. By limiting the interaction between tasks, modularity reduces the chance of cycling. The process almost becomes like nine pregnant women jointly delivering one baby in one month. Fewer cycles means a lot: Less time spent on the design. Greater probability of success. Higher quality of the finished design.

Carmakers now concentrate mainly on cutting costs. That is the best way to compete. Carmakers ferociously cut costs at their assembly plants. And they ferociously force their suppliers to cut costs. All fat was cut out long ago. Now most meat is gone too, and we are into bone. Cutting costs is good to a point. The car industry seems past the point where cost cutting yields anything but misery up and down the supply chain.

As innovation speeds up, competition can be based on time to market, not cost cutting. Modularity can make a big difference in time to market. In their book Design Rules, Baldwin and Clark cite a parable first used by Herbert Simon to illustrate how big the difference can be. In the parable, two watchmakers named Tempus and Hora both make very fine watches. Each watch has about 1,000 parts each. So the watchmakers each need a long time to put the watches together.

But the two watchmakers work differently. Tempus builds his watches in a single process, adding parts until all 1,000 have been put together. If he is interrupted—by a phone call, perhaps—and puts the uncompleted watch down, it falls apart. He has to start over.

But Hora has split his process into ten subassemblies of about 100 parts each. Once he puts 100 parts together, he has a stable subassembly. When he gets interrupted, only one subassembly falls to pieces and needs to be started over.

When there are no interruptions, Tempus and Hora make watches at the same rate. But as the rate of interruptions increases, Hora's method really starts to shine. Hora completes more and more watches than Tempus in the same amount of time.

Sometimes dramatically more. In fact, assume a one in ten chance that either watchmaker will be interrupted while adding a part to the watch. In that case, Hora can make 4,000 watches in the same time it takes Tempus to make just one.

Speed increases in other ways as well. Over 250 million cars (including pickup trucks and sport utility vehicles) travel America's roads. Just over 13 million new cars were sold in 2008. The time needed to turn over the fleet, replacing all current cars with future ones, is probably at least 20 years. So if, for example, we decided as a nation to switch over to electric cars, at normal rates it would take us a long time to do so.

Modular use makes it possible to get new technologies into the fleet much quicker. Take the power unit for example. Suppose most modular cars used a big bank of batteries, but hydrogen-powered fuel cells became practical. Many car owners might switch a fuel cell module in for a battery module, even though they would not make the change if it meant buying a whole new car.

With modular use, new technologies could appear on the market and quickly replace the old. No more 20 years for a technological generation to change.

10. Steady Revenue Over a Car's Life

Modularity lets carmakers get steady revenue throughout the life of the car. Most Americans buy a new car only once every few years, sometimes once a decade. Carmakers get some revenue (and a good bit of profit) from the later sale of replacement parts. But most revenue to carmakers comes in a big chunk, on the rare occasion when a person drives a new car off a dealer's lot.

Modular use can change that. It can smooth revenue streams out so that carmakers get steady revenue from their customers. Customers might buy a new module every year, and other parts even more often, instead of just one new car every few years.

What will the customers be buying? It could be upgrades, new products, or replacement modules. With modular use, a new module can easily replace an old one. When sub-modules are used within modules, it becomes even easier.

For example, when the car body is a separate module, the seats can be made as a sub-module within the car body, fitting into seat supports or anchors. When the seats become old or tattered, or even if the car's owner gets tired of them, they can be replaced just as easily as a couch in a living room.

Modules lend themselves to upgrades in other ways. Modules with a lot of software—like the car operating system and motor control modules—might be upgraded using the Internet. New or upgraded features to modules, like a navigation system, can be attached in a plug and play fashion.

But that need not mean waste. To the contrary. With modular use, long-life systems can be used until worn out. The electric motors in the wheel/motor modules, for example, can probably last a million miles. An electric motor has none of the tremendous pressure and heat that degrades car engines. The only parts that move against other parts are the bearings. That adds to life. Motors need not conform to changing fashion, either.

No pressure, little heat, very few moving parts, no changing fashion. Barring damage, a wheel/motor module might outlast all other modules of the car. The car's owner can spend his or her money on the other, less long-lasting, parts of the car. Each module can live out its own useful life, and be junked only when it is ready for the end, not because some other part of the car pulls it to its death along with it.

### G. PROBLEMS TO WATCH FOR

I might make the modular design, production and use of cars sound like a panacea, the ideal solution to all the problems the car industry faces. Will moving to modularity immediately solve all those problems, and the problems of oil depletion and global warming as well? Hardly.

Modularity will help with those problems, and help a lot. But modular cars carry with them, as unwelcome passengers, their own problems. A bee makes honey, but a bee also stings. Some existing problems of the car industry will remain with, or even be worsened by, modular design, production and use of cars.

On balance, these cars will be to the good, I am sure. But the problems should not be ignored. Let's look at some of those problems.

1. Complexity and Cost

Modularity will bring a lot of simplicity to cars. No longer will thousands of parts need to be tightly integrated together into a car, with complex mechanical linkages of fan belts and transmissions and fluids and cables. Much of that mess will be gone. No one will miss it.

But modular cars have their own brand of complexity. Data connections between and within modules will become more important than in current cars. Software will be more sophisticated. Motor controls will need to shape huge flows of current. There will be plenty of complexity, and that means plenty of potential problems.

Modular design, production and use of cars will drive down costs in the long run. The history of the computer industry pretty much lets us take that as a given. But in the short run, cars produced using modular design, production and use will cost more to buy than comparable traditional cars.

How much will they cost? I think that we can build and sell for about $35,000 a four-door, five-passenger car with four in-wheel motors capable of running 100 miles per gallon of diesel fuel and going from 0 to 100 miles per hour in 10 seconds. That might be $10,000 higher than a comparable traditional car.

Repair costs might also change. Will they go up or go down? Very hard to tell. The durability of electric motors and the simplicity of a four-wheel, in-wheel motor drive train tend to make us think that repairs will be less frequent, and thus less expensive.

But the fragility of complex software—its susceptibility to bugs—and the cost of maintaining software makes us wonder. Modular cars will have more software, and in more crucial places.

All things considered, at the start repairs will probably cost more for modular cars. As times goes on, they will probably cost less. But that is just my guess. Cost of repairs will be another problem to watch.

Testing can be the Achilles heel of modular designs. Even a small number of modules, if each is experimented with, creates an astronomical number of candidate solutions. Just think of cooking a dish that has 10 ingredients. Getting the best possible dish requires a lot of testing. Even so, no cook will ever be sure that he or she has the best possible combination. Too many variations exist to try them all.

2. Less Reliability, Durability, Safety

Early adopters of cars—often doctors who used them to call on their patients—quickly learned to expect trouble. A Dr. Jackson told of one car trip he made in a 1903 magazine Motor World: “Nor did the car give me much trouble. A broken bolt coming over the mountains, two connecting rod breakages and an axle nut dropping off and letting the balls out—this was the sum total.”

Our cars do much better today, enough that we now rely on our cars for years of reliable service with few repairs. Will modular cars offer the same kind of reliability and durability? They should. I think, in fact, that they will be more reliable and more durable. But only experience can answer this question. This might be a problem—we will need to wait and see.

People have been working on improving our current cars for over a hundred years. Today's car technology is mature. We know where the problem areas are, and generally how to handle them. The lengthy technological evolution of the gasoline car has already shaped it to avoid many problems that killed off earlier cars. What we have now is highly evolved.

That is not the case with modular cars. Evolution will just be beginning. Not from scratch, since much of the technology will be the same as current cars. But the concept of modularity, and the important interface specifications (design rules) required, will be new. So immature technology will be a problem to watch.

Safety might also be a problem. Even today, one out of every three cars made will have human blood on it before it is sent to the junkyard. The cars we drive today have become safer from blood spilled over generations. Brakes, for example, failed a lot more often in years past.

Carmakers learned from the gore of accidents how to make brakes better. If they did not learn themselves, trial lawyers taught them. (I will talk about car industry litigation in a later section.) From years of improvement, car brake systems rarely fail today.

Moving to modular cars means abandoning some of these time-tested systems in favor of new systems, like drive-by-wire and electrically powered brakes (or regenerative braking). These systems are not totally new. All systems will be well tested by carmakers before they make it into a car sold to the public. Some of these newer systems are already on the road in some cars.

But in many respects, cars must perform perfectly. Just like reciting a magical incantation. If one word, one pause, of the incantation does not follow perfect form, the magic does not work. Human beings are not used to being perfect. We make mistakes. Adjusting to the requirement for perfection might be one of the hardest problems of designing and building a new type of car.

No testing can compare to road testing—putting new systems into cars driven billions of miles by millions of people. Test instruments never speak as powerfully as blood and guts. One problem with modular cars is that they will require new ways of doing things that have not been tested nearly as severely as the systems they will replace. Safety will suffer.

3. Innovation can be Held Back

Modular design is not all good—it has its problems too. One problem is that separating a complex product into modules tends to isolate the technologies the modules contain. Sometimes innovations can come in how functions relate together. When that relationship is set in stone by the design rules, those innovations cannot occur. So while modularity increases some kinds of innovation, making it very rapid, it can also decrease or eliminate other kinds of innovation.

For some things take time. The progress in putting more and more transistors on computer chips—Moore's Law—has been remarkable in that progress has been steady over decades. Progress came from many big steps, not one big leap. We needed to wait to get where we are today.

Turning up the heat to cook something faster burns the outside and leaves the inside raw. As a New Orleans restaurant used to say, “Faire de la bonne cuisine demande un certain temps. Si on vous fait attendre, c'est pour mieux vous servir, et vous plaire.” (Or “Cooking good food takes time. If you are made to wait, it is to serve you better, and to please you.”) Modular approach or not, some kinds of innovation—like fuel cells or better batteries—might not happen for years, or even ever.

I think modular cars will be revolutionary, pushing current cars out of the market at all levels. But they might be more disruptive than revolutionary. In other words, they might appeal initially only to low-end users, needing to work their way up to high-end uses. The path to disruptive success is more difficult, and less certain. Whether modular cars will be disruptive or revolutionary is a problem to watch.

Carmakers have spent billions on infrastructure—plants, equipment, designs, and labor force. All that must be abandoned or overhauled to make modular cars. Car bodies and chassis will still need hefty infrastructure to make. The other modules will best be made outside the traditional carmaking camp.

Will carmakers be willing to throw away their huge infrastructure investments and start over? Probably not. That might be a problem with modular cars.

Tight integration in a complex product brings some advantages. Other things being equal, an integrated design will be more efficient than a modular design. Computer code painstakingly written in line after line of assembly language runs faster than the same code written in a modular design using a high-level language. If you need the highest possible performance, go with an integrated rather than modular design. It will be worth it.

4. Litigation and Government Regulation

New consumer products draw trial lawyers in packs. Especially complex, inherently dangerous products like cars. Then trial lawyers not only come sniffing, but drool drips off their fangs. (The imagery I use in talking of this topic shows my opinion of trial lawyers.)

As with any complex product, cars will never be perfect. You can never say of a car design that “I just fixed the last bug.” Car crashes are inevitable. Deaths will occur. Trial lawyers will pounce.

Carmaking is also heavily regulated. (The federal government only started regulating cars in 1968, but it has made up for its late entry in a big way.) Not just regulating for safety, although that is a big part of it. But also to limit pollution, to keep people from being stuck with “lemons,” and to increase gas mileage.

For example, one big barrier to entry in the highway-capable car market is the need to ruin several perfectly good cars by ramming them into barriers, and ramming other things into them. That crash testing costs millions of dollars, and takes a lot of time.

We can argue whether this kind of government regulation works well or not. (I have my doubts.) But that does not really matter. Government regulation, good or bad, is a fact of life in carmaking. And regulations are not kind to innovation. Makers of car modules might find it hard to get their modules on the market without first fighting with government regulators.

One of the problems with modular cars is that lawyers sue and governments regulate. Lawsuits and regulations keep innovation from the roads.

5. The Paradox of Choice

Mass customization of cars allows lots of choice. Most people want choice. Or at least they say they do. But some psychologists see problems with too much choice. For one thing, choice can be paralyzing, they think. When confronted by too much choice, we choose nothing.

Those who believe in a paradox of choice usually cite the jam studies. Researchers offered some shoppers the chance to taste, and then purchase, jams from a table with 6 jam choices. Another table had a choice between 24 jams. More people went to the 24-jam table and tasted jams. But more people bought jam from the 6-jam table. About 10 times more people bought. Those are very surprising results.

Scientists have studied consumer choice, and found it complex. Years ago, Alvin Toeffler said in his book Future Shock that people in the future would suffer not from no choice, but too much of it. We would become victims of overchoice. That future might be here now.

Barry Schwartz, in his book The Paradox of Choice, says that when people have no choice, life can be almost unbearable. As choice increases, we enjoy freedom and power. But as choice keeps growing, that changes. The negatives escalate until we become overloaded. Choice no longer liberates, it debilitates. Maybe even tyrannizes. All in all, Schwartz concludes, that some choice is good doesn't mean that more choice is better.

Modular cars and mass customization of cars will bring people more choice. People might not appreciate that. They might instead prefer the more limited choices they have with traditional cars. Buying a car is not like buying jam. Most of us will have to live with our choice for a long time. Paradoxically, that can make too much choice a real problem.

How choice is presented, and how people are helped to make choices, might make a big difference. I think more choice from modularity will largely be welcome. But the paradox of choice needs to be considered. It might be a problem.

6. The Problem with Standards

Like belling the cat, industry standards seem like a great idea. Industry standards need to be strong to support modularity in use. Again like belling the cat, though, creating and maintaining standards is so hard that many times the effort fails. Standards may be the biggest problem with a car industry based on modularity, apart from the possible exception of litigation and regulation.

A lot of politics goes into creating standards and there are all sorts of other problems, like backwards compatibility. One problem—who gets to define the standards? If an international body, then you are talking about years of bureaucratic red tape, and that is just to set up the process. Then you have to have more years to actually produce something. If standards are set by companies that make modules, then they will move a lot faster. But you will get competing standards, like BetaMax vs. VHS, DVD+R vs. DVD-R, Blu Ray vs. HD-DVD.

Here again, the computer industry can be a guide. Computer networking standards provide interesting history. Compare the ISO approach, which uses a very bureaucratic process, with the IETF approach, which is relatively informal. The IETF approach worked well as the basis of the Internet, which far exceeded the original parameters. The ISO approach seems to work better for industries that grow more slowly.

Another example—web browsers, HTML, and JavaScript, where Microsoft allegedly sabotaged web programming. Microsoft supposedly helped create the standards and then did not follow them. Whether that is true or not, no question that one powerful organization can undermine work done by a lot of other organizations.

Backward compatibility also poses a problem. Look at what has happened with Microsoft Windows, where for years (and even now, according to some people) there were remnants of DOS in the system. There were (and may be still) performance penalties as a consequence.

Since the Society of Automotive Engineers already exists and has made standards, defining the standards for modularity in carmaking might be easier than the standards wars fought in the computer industry. But we cannot count on that. Standards will need to be carefully created and maintained. Even so, they will bring some problems.

### H. FORMING A FRAMEWORK FOR MODULARITY

Modularity makes you do things differently from current carmaking. You need to first form a framework to support it. Let's look at how that framework might be formed.

1. Divide Car Functions into “Black Box” Modules

Modularity in carmaking begins by dividing the car into functional systems. With a gasoline car, this cannot be done well. The car and its functions are integrated, not distributed. Sophisticated mechanical connections need to link systems, like the engine and the transmission, together. Even the steering system connections are complex.

Designers have to work around all these connections, designing the gasoline car as an integrated whole. Without careful attention to how systems connect and work together, the car will not work. No one function can be a “black box” to the designers of other functions. Those designers need to know how the function is being performed.

Unlike a gasoline car, an electric car can be divided into functional systems. Complex mechanical connections in gasoline cars become electrical cords (power cords and data buses) in electric cars. Thought still must be given to what functions go into each module. But many different divisions will work.

My example divides the car's functions into seven modules. FIG. 8 shows how the functions of a car can be divided into modules.

2. Define Interfaces Between Modules

An important part of the “black box” standards will be to define each module by the interfaces between it and other modules. Creating the interfaces tells the designer what each module must get from other modules and what it must give to other modules.

That information is important. It frees up developers to design modules in parallel. They do not need to wait until another module is designed to know what their module has to do. They just need to make sure their module fits within the specification of the interface.

Today's cars have some interface specifications. All gasoline cars can be fueled by the same type of gas pump nozzle, for example. Batteries and cars hook up with standard electrical cables and a mechanical connection (usually some sort of clamp). Tires too have a standard interface, defined by a set of numbers, like P215/70R16 100S, that appear on the tire's sidewall and give its size and performance specifications.

Those kind of specifications will need to be expanded. Everyone must understand the interfaces and specifications for each module. If not, the modular process will not work. Like the Tower of Babel, any project where people are not, at some level, speaking the same language will fail.

FIG. 4 shows the connections, or interfaces, between the seven modules in my example. Defining these interface specifications will not be difficult for those skilled in the art. So my example does not do that defining.

3. Set Standards for Module Architecture and Interfaces

To create “mix and match” modules, a carmaker needs to create standards for “black box” modules that anyone can design to, letting other car or module makers participate in modular design. The standards for each module will include size, weight, input (both power and data), output (both power and data), and the structure of connections to other modules.

One important thing to remember about the standards for each “black box” module: The standard tells what the module does. The standard does not tell how the module does it. The “how” is left up to the designer. Whatever technology works, fine. Even magic, if you can make it work. As time goes on, the advances in technology brought about by modular design might make future solutions to the module problem look like magic to today's designers.

These standards will need to be specific. In addition to all the physical requirements of the module, safety will also be a concern. And the standards will evolve as the technology evolves. Otherwise, they will tend to freeze out new innovations and limit imaginations and solutions to those being used today.

Some might think that a module maker can design its own module better if it understands well how the other modules work. Practical experience proves the opposite. As Frederick P. Brooks notes in his “The Mythical Man-Month,” in designing software, a programmer does his or her most effective work if shielded from, rather than exposed to, the details of construction of system parts other than his or her own. We can expect the same from modular design of a car.

Many different interface specifications will likely emerge. The Society of Automotive Engineers might be the ideal body to set industry standards for module architecture and interfaces. To start, though, all that is needed is one standard, set between the makers of each of the different modules.

4. Develop Tests for Modules and Assembled Cars

Modularity requires testing. When software is tested, ideally each of the modules is tested, and then they are integrated in a system test. Just because each module passed its individual tests, you cannot assume that they will work together correctly. You need to test that.

The modules in software are usually not as well-defined as the car modules will be. But there still needs to be a provision for running tests on the modules after the car is assembled. A standard test suite would help a lot with this issue. Perhaps the United States government could help. Especially since car industry history shows that the government will make sure it is involved anyway.

### I. BRINGING MODULARITY TO CARMAKING

Some people think the carmaking industry is mature, with only evolutionary innovation and slow growth. Bringing modularity to carmaking can change that. Let's look at the basics of how modular design, modular production and modular use can work in carmaking.

1. Modular Design in Carmaking

If you split carmaking into the three steps of design, production and use, then design will always come first. To get the full power of modularity, you need to first do modular design. FIG. 9 shows modular design, without doing modular production or use.

FIG. 9 shows modular design for a car split up into three modules: body, chassis, power train. Each of the modules is designed separately, a “black box” that can do the module's task any way its designers please. But the module must follow the design rules, both the rules that tell how the module must connect to other modules and the rules that tell what task the module must do.

The modular design process for the seven-module “truly electric car” I describe above and elsewhere is the same.

2. Modular Production in Carmaking

Modular production of a car is simple. You just make each module separately, to completion. Only then do you put the modules together. FIG. 10 shows how this might work for a three-module car.

The power train modules, for example, are made to specification so that they can be “mix and match” assembled with the two other modules of the car. Not put together like a jigsaw puzzle where each new piece makes the final picture more and more definite. Big chunks instead of small pieces.

3. Modular Use in Carmaking

Modular use of a car depends upon modular production. If parts of a car are not made in modules, they cannot be used in modules. But when design rules are made public and apply across an industry, modular use can dramatically change what makers, sellers and buyers do.

Modular use has become common in many industries, opening up the market for both makers and users. Not having the rules that make modular use possible limits the market. Imagine, for example, that every mattress company made their mattresses in a unique size. Serta different from Simmons. When you bought a mattress, you would probably then need to buy a bed, sheets, blankets, and pillows at the same time to fit that unique size. Or makers of those products would need to offer a variety of sizes that might fit some mattresses well and others less well.

Some car parts already have standards. Tires come in standard sizes. So do wheels and starter batteries. And car radio/music players. The Society of Automotive Engineers has developed lots of standards—thousands of them—followed by all the carmakers and the parts makers that supply them.

Expanding those standards so that modular use can be used for the entire car will bring great benefit. FIG. 11 shows how modular use of a three-module car might work.

### J. OTHER WAYS MODULARITY IN CARMAKING MIGHT WORK

1. Each Car Mass-Customized for its Owner

Mass customization means tailoring a product to each buyer, but selling it at a mass production price. Like hand-tailored suits at off-the-rack prices. Carmakers call this a “built to order” car. Some built-to-order cars are made even today. Rare in the United States, they are popular in Europe. About one-fourth of new car buyers there order a car built just for them, then wait a few weeks, or even months, for it to come.

But only limited customization can be done in a gasoline car. You can not, for example, order the engine and seats from a Porsche and slot them into a Jaguar. With an electric car and modular use, you could. Like Dell computers, but with cars instead.

Modularity in carmaking can be done by carmakers selling each car buyer a car mass-customized to them alone. That is sometimes called selling to a market of one. Each buyer can choose from a variety of modules and sub-modules. Then the carmaker can arrange for those modules and sub-modules to be assembled and the car delivered. The buyer can later buy other modules and sub-modules as upgrades or add-ons.

2. Car Industry Players Take New Roles

Modularity in carmaking can be done by giving car industry players new roles. To mass customize a car, module makers need to design and make modules that meet design rules. That lets carmakers offer car buyers choices very late in the production/assembly process. With build-to-order of gasoline cars, the car buyer's order needs to start early in the factory and be followed all through a complex manufacturing process. That costs time and money. Pushing the customization out as far as possible lets car buyers enjoy more variety at the same cost.

Parts suppliers will support module makers, rather than carmakers. Ideally, modular design, production and use will not just be at the car systems level—the seven basic modules making up the car in my example. Instead, other components and systems making up the modules will be designed, made and used as sub-modules. Seats, for example. Steering systems. Electronic suspensions. Batteries. All these could be offered as sub-modules to both module makers and end users.

Like Dell with its computers, carmakers could sell cars made up of modules. Nothing, of course, would stop a carmaker from also being a module maker, even making all the modules. But with their dealer networks, valuable brands, and experience, carmakers will likely be best at selling mass-customized cars to buyers.

The major carmakers now dominate carmaking. Other companies—like the parts suppliers—have only a supporting role. Modularity in carmaking can be done by giving module makers starring roles of their own in the car industry. Just like Microsoft and Intel have long been stars of the computer industry, new companies will emerge as car body makers, wheel/motor makers, and the like. New stars will shine.

That does not mean that the major carmakers will disappear. Carmakers might become module makers. Or take the role of systems integrators—a role they tend to play more and more anyway as the car industry shifts production from the carmaker down the supply chain. Or they might focus on sales only, building up their brand. Predicting how the car industry will change is difficult. But as modularity takes hold, change is inevitable.

3. Car Made Only After Ordered by Buyer, but Quickly

Modularity in carmaking can be done by a carmaker making a car only after it is ordered by a buyer, but still doing it quickly. Ideally, car modules will be kept in reasonably diverse inventories in, for example, most cities across the United States. They can then be assembled locally, after a car is bought. The complete car can be provided quickly to the buyer just after it is ordered.

Doing that now is hard to do. A special order for a car needs to be handled in a central factory. Making the car takes time, and so does shipping the assembled car to the buyer. European carmakers do much better at this than the Detroit Big Three.

But nobody does it as well as you can do it with modular production. With conventional carmaking, building to order is forced. With modularity, building to order is natural. What Dell has done for computers, a carmaker can do for cars, if modular production can be used.

4. Buy Modules from Best-of-Class Suppliers

Modularity in carmaking can be done by letting carmakers choose among modules from best-of-class suppliers. No longer do carmakers need to develop all the technology needed for a complete, integrated car all by themselves. If someone else can build part of the car better or cheaper than they can, a carmaker can take advantage of that. Any carmaker can easily use a best-of-class module in its own car.

That lets, for instance, a software company develop a car operating system that will work on any car in the world. The same operating system, for any car. Think Microsoft Windows, but for cars. That can be done with software because it costs almost nothing more to copy a complex operating system than a simple one. So the operating system can be loaded with everything, and for simpler cars parts of it will just not be used.

Module makers might get an advantage too—they can potentially sell to the whole car market. Anyone now who does not sell a complete car can sell only to a limited market, often to just one carmaker. So it's hard in the car industry for any new company, or a company with new technology, to put together a good business case and get funding. That lack of a broad market to sell to is one difference from the computer industry that matters, and matters a lot. Modularity in carmaking changes that.

5. Use Carmaker Brand on Modules Made by Others

Modularity in carmaking can be done by letting carmakers put their brand on cars where everything is made by others. Just like a computer company like Dell, who has focused its innovation on sales rather than manufacturing. Dell puts its brand on computers that do not have a single part that was either developed or made by Dell.

Or to take another example from the computer industry, many computers made and sold under the maker's brand have an Intel processor inside. A label on the computer says exactly that: “Intel Inside.” That's co-branding.

With modularity, carmakers could do that kind of thing too. Some car companies do it already. Magna-Steyr builds a lot of cars—built and driven off the Magna-Steyr assembly line as finished cars—that bear a BMW label. Not only does Magna-Steyr do the assembly, but the BMW car contains some of Magna-Steyr's technology as well.

Co-branding and co-marketing can be done with modular production. Conventional carmaking makes it hard to do. Not impossible, but hard. Some might still remember “Body by Fisher” advertising by GM that lasted through the 1950s and 1960s. The Body by Fisher logo emphasized the strength that Fisher had in designing and making car bodies. But the Fisher Body Corporation had been absorbed into GM in 1926, so it was not really co-branding.

We do see co-branding in some car parts—Firestone tires on Ford Explorers is an example (an unfortunate case as the faulty tires did much harm to Ford and especially Firestone)—but not much. Certainly not co-branding at a module level. Modularity opens up the car industry for lots of new marketing ideas that can change the very nature of making and selling cars. Maybe even let some carmakers and module makers make a consistent profit. That would be welcome.

6. Modules Assembled Locally, to Fit Locality

Modularity in carmaking can be done by making assembly simple enough to do at a local service station, dealer or repair shop. Some modules will be heavy—like the body, the chassis, and the wheel/motors. Since these heavy modules must be mechanically attached, casual do-it-yourselfers are unlikely to try assembly at home. But assembly will be freed from factories.

Modularity brings assembly out of a central factory and into a local service station, dealer or repair shop. That changes the whole dynamic of the production process, for the better. It also makes it easier to fit the car to the locality. Cars in Honolulu, for example, might have different modules than in Chicago.

7. At Delivery, Carmaker Helps New Owner Customize Car

With conventional carmaking, car dealers do add some accessories at the dealership. A nicer knob for the gear shifting stick can be put on, for example. Or wood-inlaid steering wheels. Or mudflaps and running boards. But that's not really customizing in the sense most customers would want. That's just adding a few fashionable touches rather than radically different features or functions.

Modularity in carmaking can be done by a carmaker helping a customer customize his or her car at delivery. Modules can be made to fit together with a variety of other modules, giving a car buyer a choice beyond just the basics. Carmakers can make modules that fit on all kinds of car models. A night vision package can be added, for example. Or rear-view cameras can replace minors. Or a steering/braking/accelerating yoke can replace a steering wheel and pedals. All done on the spot. That kind of option can really customize a car.

8. Carmakers can Use Modules Made by Others

With modularity, a carmaker can make a car by mixing and matching modules made by others. As long as the modules meet the design rules, they will fit together with other modules to make a working car. A carmaker need not define its own specifications, as it must do now. Instead, it can rely on design rules that rule across the industry.

That being said, carmakers might well want to work closely with module makers, or even make some or all of their own modules, to improve the quality of their cars. Feelings of noise, vibration and harshness, for example, will give car buyers a bad impression about a car. When Toyota first came out with its Lexus brand, it spent a lot of money on engineering to reduce those three bad qualities. Car buyers pay a lot of attention to this. That will not change with modularity.

Carmakers who put together a car from modules want cars that work well as an integrated whole. That is what car buyers and drivers will care about. So we should see different models among carmakers—just like the different personal computer models from Dell, HP, and Apple—as they decide how they will use modules to make cars.

9. Buyers can Mix and Match Modules

Modularity in carmaking can be done by letting car buyers pick and choose modules to build their own car. Many computer buyers do this now. They order the different parts off the Internet—operating system, case, processor, motherboard, memory, hard drive, video card, monitor, keyboard, mouse—and put them together themselves. Car buyers can do the same. (But assembling the large, heavy and awkward modules of a car will best be left to professionals. Few if any will try assembling the modules at home. And shipping charges might be steep.)

Will many people pick and choose modules to design their own car? Hard to say. My guess is probably not. We tend to be a lot more tolerant of our computers crashing than our cars. Most of us will probably want the added security of a carmaker standing behind the design and integration of the modules. Just as most people buy a personal computer rather than make their own. Maybe more so.

But that might change. We use our cars longer than our personal computers. The average life of a car on America's roads is more than 15 years. The average life of a computer is probably a third of that. Since different modules will have different lifetimes, car buyers might start to see cars more as a collection of modules than an integrated car. That might make them more comfortable buying modules than cars.

10. Upgrade Modules, Not the Whole Car

Modularity in carmaking can be done by letting car owners replace modules later. Tired of your car's body? Buy a new one. Put it on the same chassis. Plug it in. It works. There will be limits. The new car body must be designed—size, weight, configuration—to fit on the old car chassis. As long as they do meet the same design rules, though, modules can be replaced without replacing the whole car.

Replacing modules makes the most sense when different modules have different lifetimes. Electric motors, for example, tend to be very durable. Only the bearings move relative to each other. That reduces friction. Based on the lifetimes of comparable stationary motors, electric motors to power cars might often last a million miles. Maybe more. As long as the motors run well, no reason to change them. Their old-fashioned looks will not matter.

Car bodies, though, will age more quickly. Not just with use, but with fashion. When we look at a car, we see the body. Wheels and tires too, of course, but they give a much less powerful impression. Predictions about fickle things like fashion are very hard to make. But when people can get a new car body at a fraction of the cost of a new car, they might well choose to do that, earlier and more often than they would buy a new car.

So modularity in carmaking can be used to let cars evolve over their long lifetimes. Especially since modularity can be used to let car owners upgrade their modules as technology changes. Hardware, and especially software, modules can be replaced to make an old car perform like a new one.

Power modules might be the most important upgrade. Technology for storing and generating electricity seems to get better every year. By upgrading a power module, a car owner would get better results without buying a new car.

But software upgrades might be the big opportunity for carmakers. A carmaker might sell over the Internet a new feature (like electronic stability control) as a downloadable software upgrade. That would be a new approach in the car industry—a new feature provided solely by software. The cost of making and distributing a copy of the software will be small compared to the purchase price. Gross margins might be more than 90%—a real rarity in the carmaking industry.

11. Seeking Investors in a Specific Technology

Modularity in carmaking can be done by setting up a car company that seeks investors who invest in one specific technology used in a car. That's as opposed to today's investment choices, which are either carmakers making integrated cars or parts suppliers. Neither carmakers nor parts suppliers now attract much venture capital.

The time to market (often 5 to 7 years) and the amount of upfront capital needed (usually at least $200 million) have kept most venture firms from investing in new carmakers. The poor margins and lack of a market (only carmakers buy from them) for parts suppliers limits their appeal. With modularity, venture firms and other investors can invest in a specific technology. That's much more appealing, in terms of time to market, upfront capital, and size of market.

With modularity, a startup with new car technology can get started with normal venture rounds, starting with angel funding and going through the normal growth process. That will make for a vibrant industry. Failure will be common, but no company will be too big to fail. The health of the carmaking industry will improve as “creative destruction” weeds out zombie companies that cannot survive. The assets they would consume, and their market share, can go to more healthy companies.

12. Selling Functions as Add-Ons

An example of modular use might be a self-parking module. Most of the module's functions will come from software. Sensors might be needed as well. A radar-type sensor could sense where the curb is, and any cars to the front or back of the parking space. The car operating system could calculate the degree of turn for the steering and provide power to turn the wheels correctly.

This module would not be one of the seven that make up the car. Self-parking would be a sub-module attached to the car body and the car operating system modules. By making cars able to accommodate sub-modules, this kind of function can be put in any car easily.

Other special functions that might be implemented as add-on modules include:
Vanpool tracking and optimization software
Autopiloting using artificial intelligence
Vehicle lane control
Collision avoidance systems
Publicly shared vehicles

13. ?

How will cars evolve with modular design, production and use? The best answer is “?”—a question mark. We don't know. One characteristic of modularity is that it is a process, not an end. We must set the process loose, and see what evolves from it.

Were I to predict where carmaking will go from here, I would be wrong. Too many factors will come into play. If we look back 100 years ago to the predictions people made then, they were far wide of the mark. No one predicted nuclear weapons, for example. Or the Internet. Or lasers. Yet these things all have important roles in most people's lives today.

If we make predictions, and try to make them come true, we limit ourselves. For when it comes right down to it, we often do not really want what the future will bring. Henry Ford once said that “If I had asked my customers what they wanted, they would have said a faster horse.” We don't want the uncertainty of the future. It's too scary to think about that. We just want the present, improved.

Computer history shows us how that works—how our imaginations limit us. Popular Mechanics in April 1968 told how the Sutherland family put a computer in their house. First use—to complete the family finances “automatically.” They then hoped to extend the system to do more wonderful things: Store recipes. Compute shopping lists. Track family inventory. Control home temperature. Turn appliances on and off. Predict the weather.

The next year saw worse. Honeywell's “Kitchen Computer” went on sale in the 1969 Neiman Marcus catalog for $10,600 (including a two-week course in programming it). What did it do? If you selected an entrée, the computer would use a recipe databank to suggest the rest of a menu built around it. Or you could enter the ingredients on hand, and the computer would tell you what recipes you could make.

Even today, people do not use home computers to work with recipes or to control their furnace or refrigerator. These failures of prediction are common. None of us can predict the future. But even if we cannot predict (or even imagine) where we will end up, does it really matter? As Ursula K. Le Guin said, “It is good to have an end to journey towards, but it is the journey that matters in the end.”

There can be excitement in a journey even when you do not know where you are going. Maybe it's even more exciting that way. The modular approach to carmaking may lead to a sort of global Manhattan Project: good minds, and a lot of them, working on different parts of electric car technology.

Battery people working on batteries, motor people working on motors, software people working on software, designers working on car body designs. No one knowing exactly where the car they are contributing to is going. But all working hard to get their part of it there.

Wherever we are going, modularity will make the pace quick. People will experiment more. Most ideas will fail. Those ideas that succeed will be born and on the market sooner. Short generations drive evolution. Fruit flies evolve faster than elephants.

That quick pace might create a buzz, a feeling of excitement, in shared communication, experimentation and discovery. The early days of any technology must have been the same. The early days of flying. Or of radio—when kids on remote farms tuning in on crystal sets were thrilled just to hear a distant time signal.

We will be pioneering. We won't be like the climbers up El Capitan, since we don't yet know—can't yet know—where we will end up. But maybe that won't matter.

As discussed above, with modularity we may be able to build a vibrant new modular carmaking industry. We will not know where our journey will end. But it may be an exciting journey. And perhaps it is the journey that matters in the end.

Will you join us?

### K. THE DRAWINGS

FIG. 1 shows some prior art of how a hybrid electric car can be presented to customers.

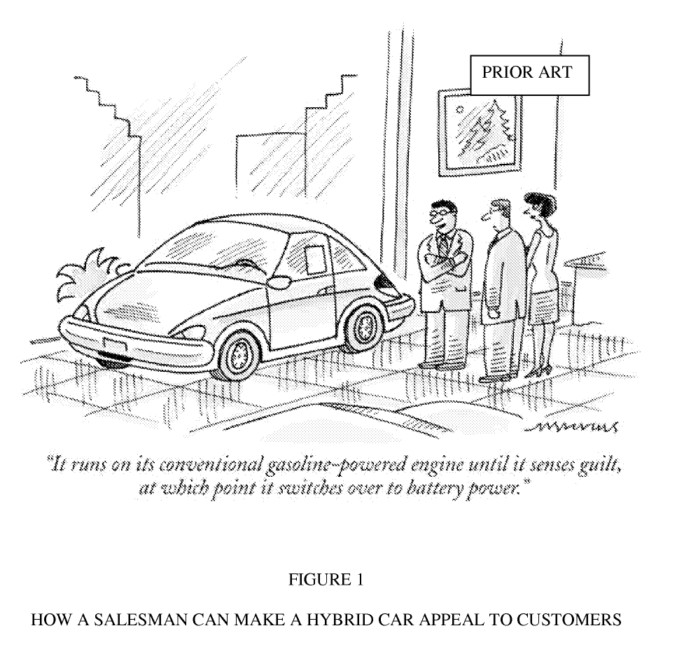

FIG. 2(b) shows how the carmaking industry can change from being a stagnant “vertical” industry with a few giant carmakers to a vibrant “horizontal” industry with thousands of profitable companies. FIG. 2(a) shows a model for that—the computer industry.

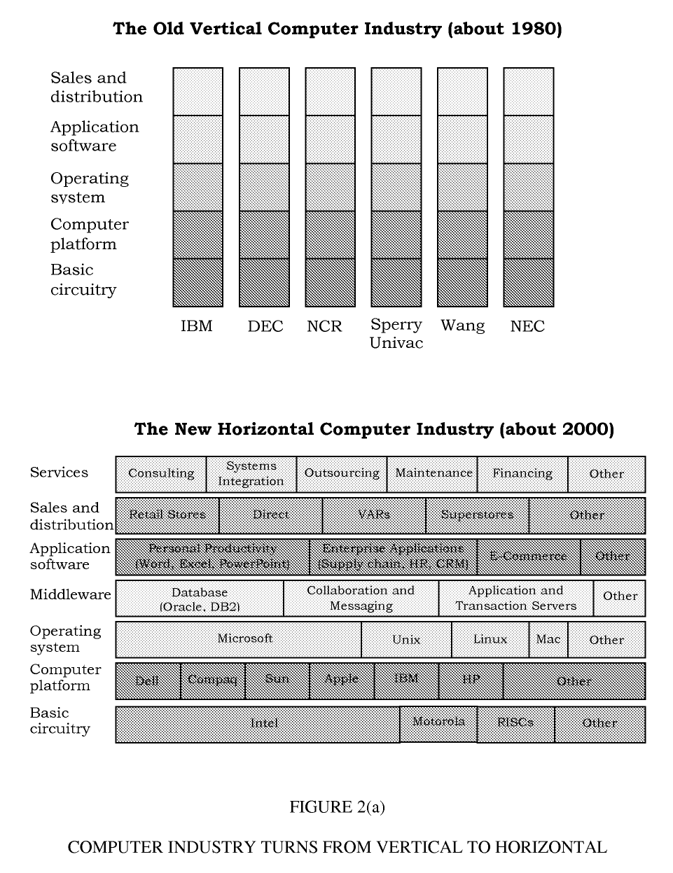

FIG. 3 shows how mass customization of cars can give car buyers 279,936 different car possibilities by offering just 7 choices.

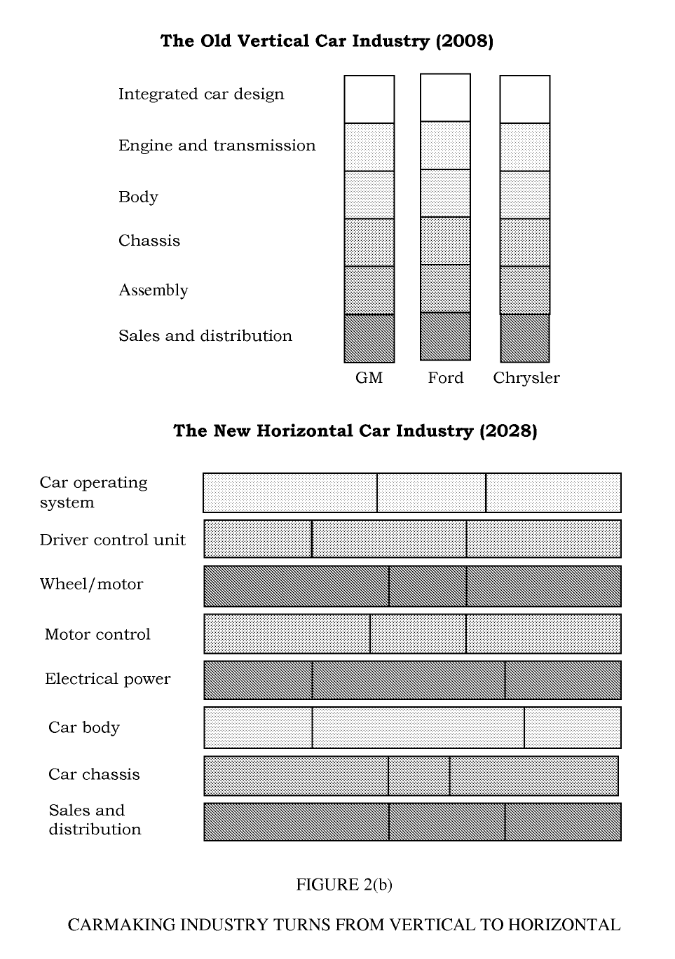

FIG. 4 shows how a modular car with seven modules—car operating system, driver control unit, wheel/motors, motor controls, car body, car chassis, and power unit—might work.

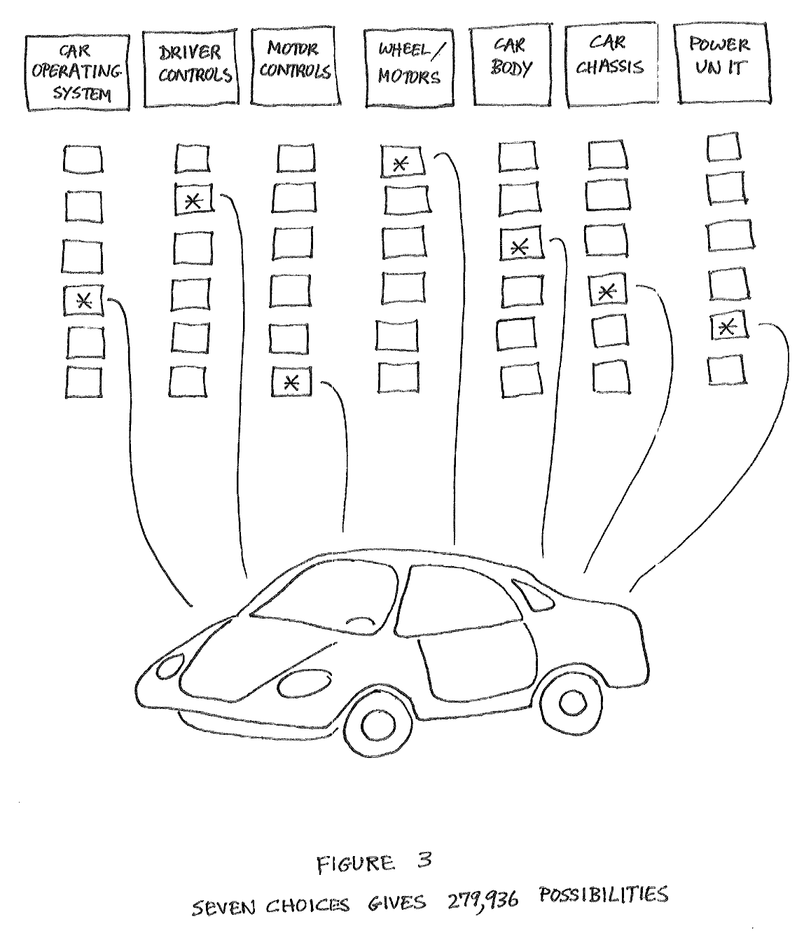

FIG. 5 shows how current carmaking might compare with modularity in carmaking.

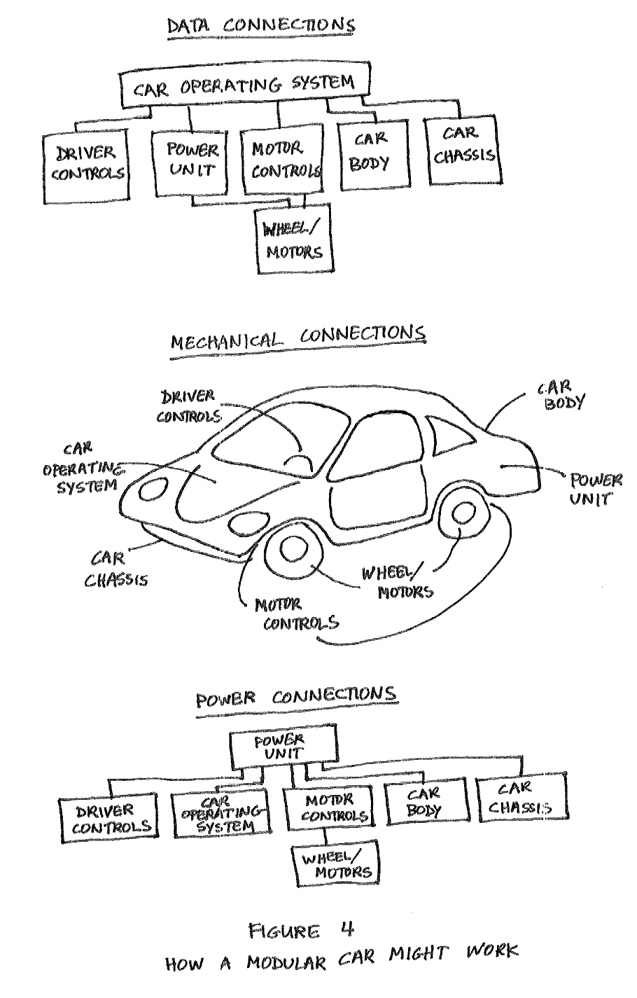

FIG. 6 shows how a car operating system might work.

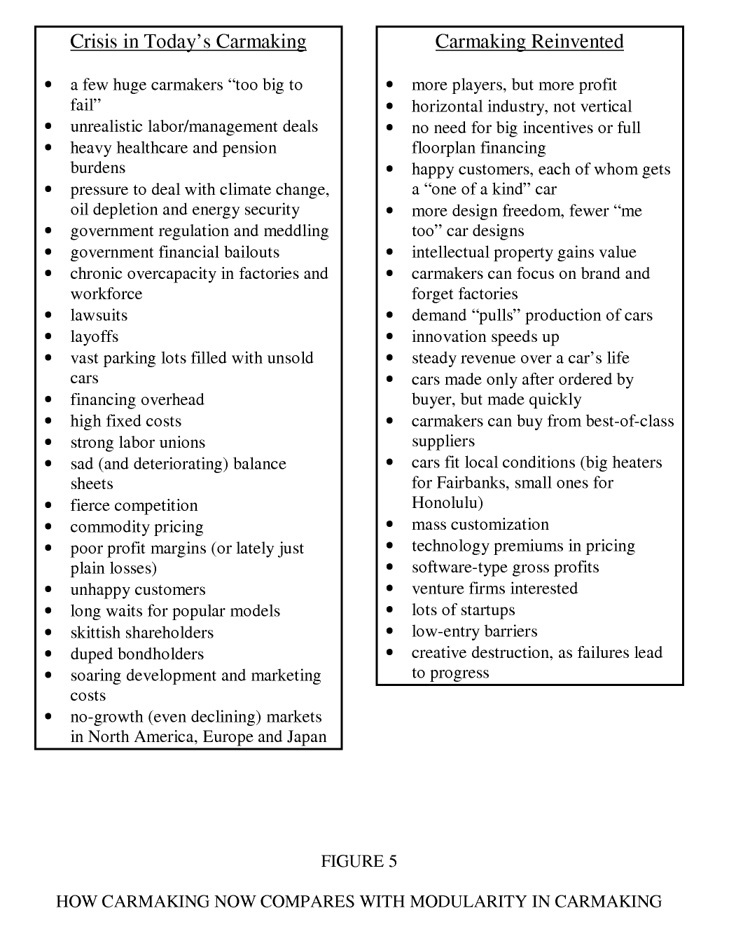

FIG. 7 shows what must be done to form a framework for modularity in carmaking.

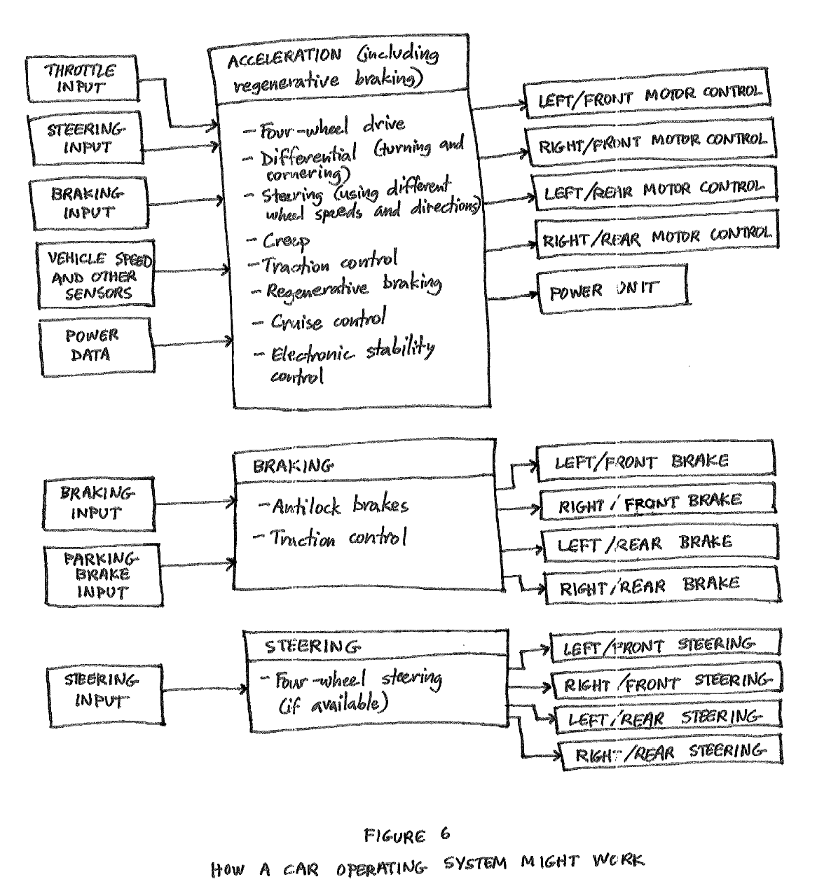

FIG. 8 shows how the functions and parts of a car can be split into modules, then sub-modules, then into sub-sub-modules, and so on.

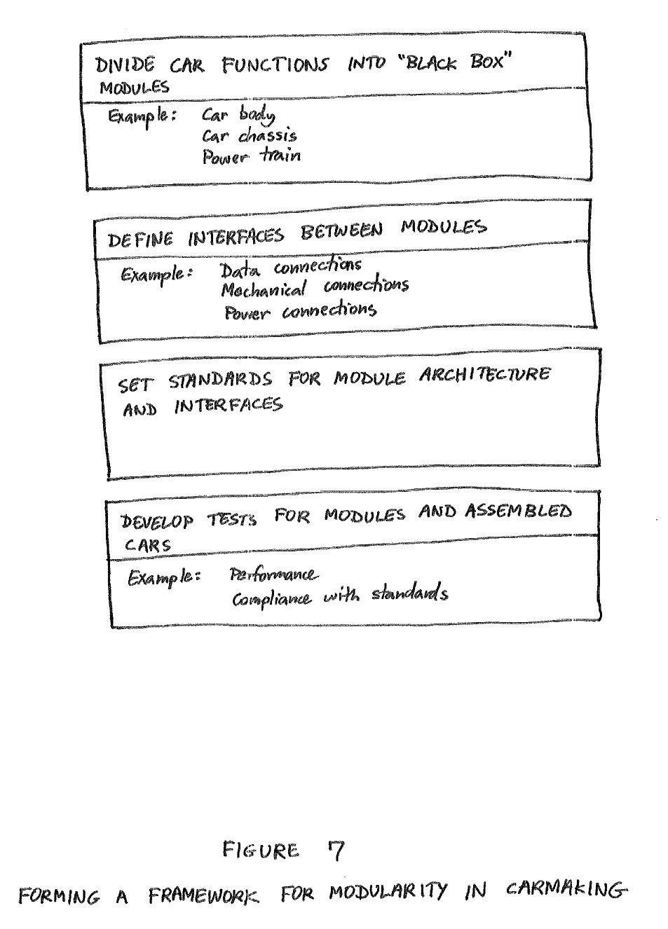

FIG. 9 shows how modular design of a car might work.

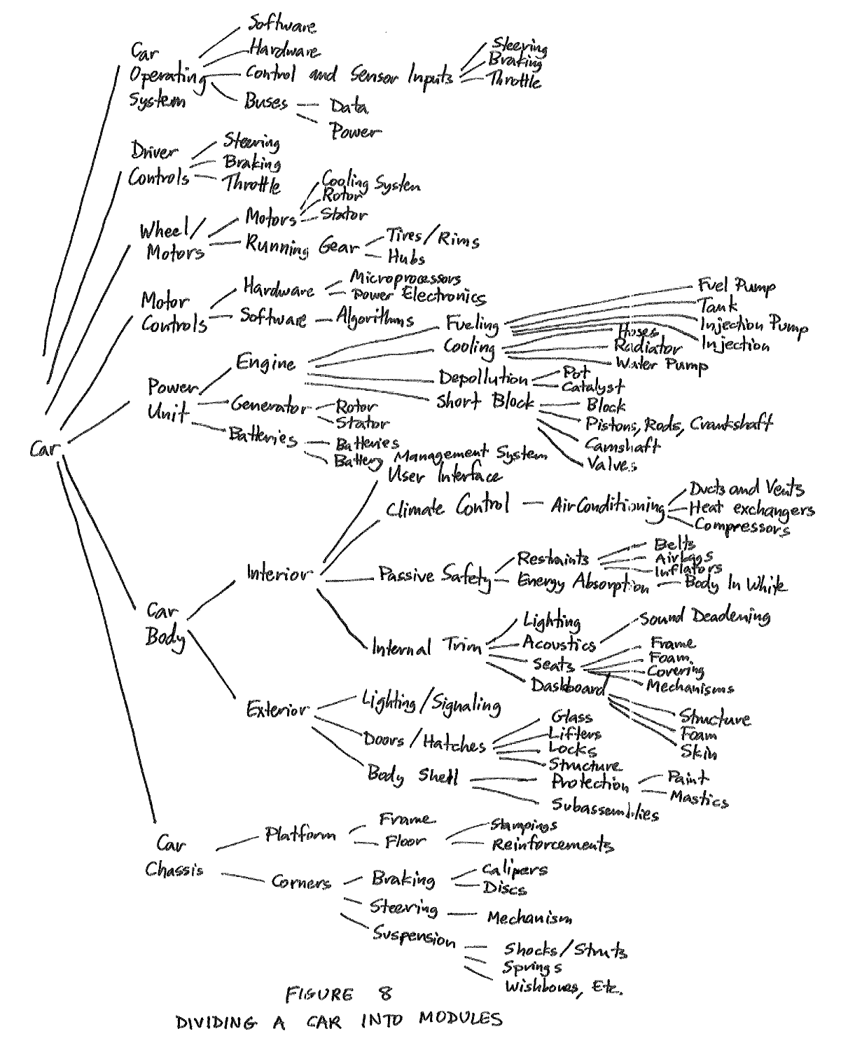

FIG. 10 shows how modular production of a car might work.

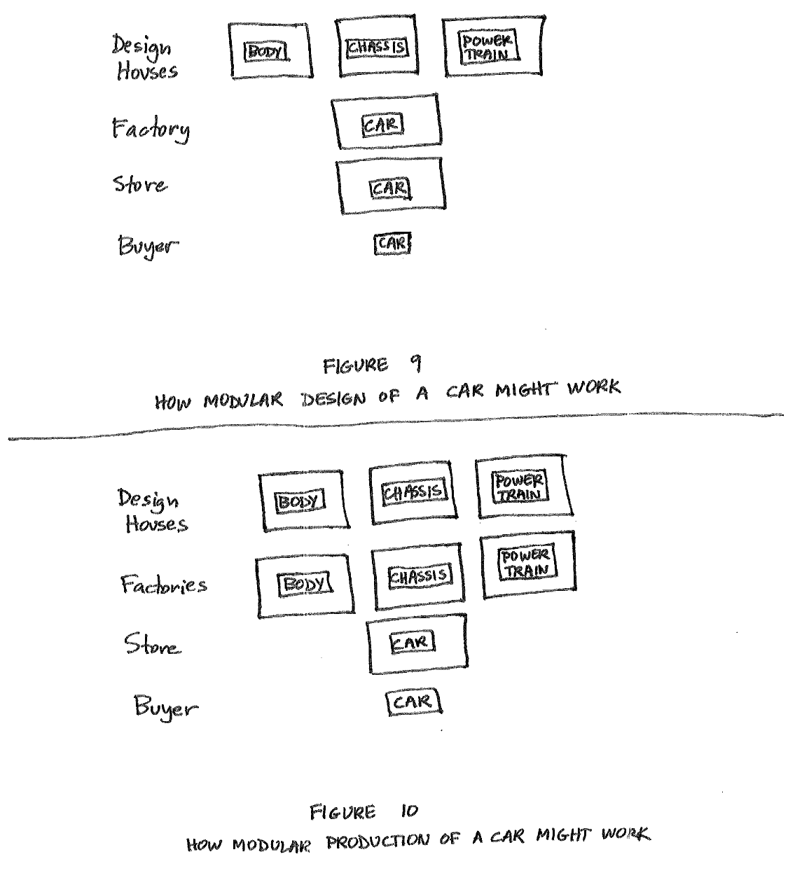

FIG. 11 shows how modular use of a car might work.

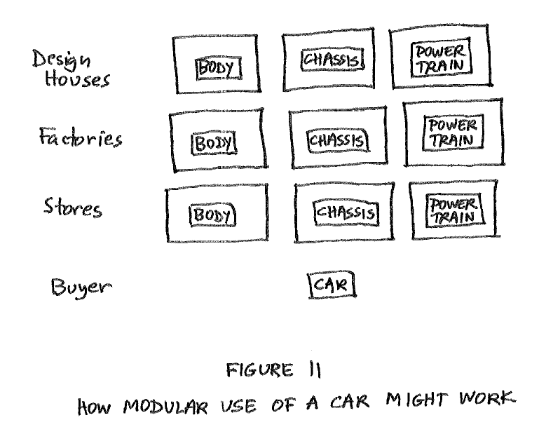

I claim:

1. Re-inventing carmaking by the design, production and/or use of a module for a car (or other vehicle).

2. The re-inventing carmaking of claim 1 where the module is one of at least three black-box modules that together make up a complete car.

3. The re-inventing carmaking of claim 1 where the module has interface specifications defined for a mechanical, data and power connection to at least one other module.

4. The re-inventing carmaking of claim 1 where the module was designed, produced or used according to a framework for modularity based on one or more of the following steps:
(a) divide car functions into black-box modules,
(b) define interfaces between modules,
(c) set standards for module architecture and interfaces, and
(d) develop tests for modules and assembled cars.

5. Mass-customizing a new car (or other vehicle) by customizing the car for each buyer but selling the car at a mass production price.

6. The mass-customizing of claim 5 where the car is divided into at least three black-box modules that together make up a complete car.

7. The mass-customizing of claim 6 including the steps of:
(a) giving the buyer at least two choices for at least one of the three black-box modules, and
(b) making a complete car by assembling the chosen modules.

8. The mass-customizing of claim 6 where each module has interface specifications defined for a mechanical, data and power connection to at least one other module.
